(19) United States
(12) Patent Application Publication
(10) Pub. No.: US 2023/0067651 A1
(43) Pub. Date: Mar. 2, 2023

(54) Systems and Methods for UV-Reflective Paints with High Overall Solar Reflectance for Passive Cooling

(71) Applicant: The Regents of the University of California, Oakland, CA (US)

(72) Inventors: Jyotirmoy Mandal, Prinecton, NJ (US); Aaswath Pattabhi Raman, Los Angeles, CA (US)

(73) Assignee: The Regents of the University of California, Oakland, CA (US)

(21) Appl. No.: 17/904,366

(22) PCT Filed: Feb. 24, 2021
(86) PCT No.: PCT/US21/19448

§ 371 Date: Aug. 16, 2022

Related U.S. Application Data
(60) Provisional application No. 62/980,998, filed on Feb. 24, 2020.

(51) Int. Cl. C09D 5/33; C09D 5/03; C09D 7/20; C09D 7/43; C09D 7/61; C09D 7/65; C09D 7/40

(52) U.S. Cl. CPC C09D 5/004; C09D 5/037; C09D 7/20; C09D 7/43; C09D 7/61; C09D 7/65; C09D 7/68; C09D 7/69

(57) ABSTRACT

As climate change and global energy consumption manifest in rising global temperatures and heat-islands, cooling living environments has become an urgent challenge. In developed settings, air-conditioning of buildings consumes energy, generates heat and releases greenhouse gases—exacerbating cooling needs. In developing regions, such as South Asia and sub-Saharan Africa, inadequate power infrastructure for cooling buildings has led to rising casualties during summers. Passive cooling technologies, which are sustainable alternatives to active cooling methods are provided. Systems and methods for passive radiative cooling coatings are provided as an effective approach for passive daytime radiative cooling of buildings.

### CROSS-REFERENCE TO RELATED APPLICATIONS

The current application claims the benefit of and priority to U.S. Provisional Patent Application No. 62/980,998 entitled “Methods and Systems for UV-Reflective Paints with High Overall Solar Reflectance for Passive Cooling of Buildings” filed Feb. 24, 2020. The disclosure of U.S. Provisional Patent Application No. 62/980,998 is hereby incorporated by reference in its entirety for all purposes.

### FIELD OF THE INVENTION

The present invention generally relates to methods and systems for effective radiative cooling of buildings; and more particularly to utilizing UV-reflective paints with high overall solar reflectance as an effective radiative cooling system for buildings.

### BACKGROUND OF THE INVENTION

As climate change and global energy consumption manifest in rising global temperatures and heat-islands, cooling living environments has become an urgent challenge. In developed settings, air-conditioning of buildings consumes energy, generates heat and releases greenhouse gases—exacerbating cooling needs. In developing regions such as South Asia and sub-Saharan Africa, inadequate power infrastructure for cooling buildings has led to rising casualties during summers. Passive cooling technologies, which are sustainable alternatives or complements to active cooling methods, may address these issues.

### BRIEF SUMMARY OF THE INVENTION

Systems and methods for effective radiative cooling are illustrated. Many embodiments provide coatings with a high overall solar reflectance and a high thermal emittance for passive daytime radiative cooling. Some embodiments implement broadband emitters and/or selective long wave infrared (LWIR) emitters in coatings. In several embodiment, coating materials can be a broadband emitter with a high solar reflectance. In many embodiments, broadband emitters are better suited for radiative cooling than selective LWIR emitters. In several embodiments, broadband emitters are better suited for cooling at near and/or above-ambient temperatures. In many embodiments, the coatings can be in a form including (but not limited to): paint, spray, and dry coatings. Many embodiments provide applications of coatings including (but not limited to): non-aqueous coatings and aqueous coatings.

Many embodiments provide composition materials of effective radiative cooling coatings with a high solar reflectance of at least 0.94. Many embodiments provide that coating composition materials with low and high refractive indexes (n) in the solar wavelengths can maximize refractive index contrast across constituents of the coatings, enhancing the scattering of UV and other solar wavelengths and hence enhancing reflectance. In several embodiments, high refractive index materials with refractive index of at least 1.5 can be used as pigment materials in effective radiative cooling coatings. In many embodiments, low refractive index materials with refractive index of less than 1.45 can be used as pigment materials and binder materials. In several embodiments, refractive difference of the mixture composition materials has an absolute value of greater than 0.1.

Many embodiments implement at least one pigment material in coating materials that have high solar reflectance. Properties of the pigment materials can include (but are not limited to): high solar reflectance, high UV reflectance, and non-UV absorptive. Several embodiments provide that the pigment materials are in a powder form with a wide size distribution for broadband solar scattering. Many embodiments implement at least one binder material in coating materials that have high solar reflectance. Binder materials in accordance with some embodiments may have low to negligible UV absorptivity, low near infrared absorptivity, and/or low-refractive index. Several embodiments employ a mixture with a high pigment to binder volume ratio to achieve at least one air void (n of about 1) and maximize refractive index contrast and enhance reflection in the solar wavelengths.

One embodiment of the invention includes a passive daytime radiative cooling coating comprising at least one pigment material with a refractive index of greater than 1.5, at least one binder material with a refractive index of less than 1.45, and at least one solvent, where the at least one binder material is soluble in the solvent, an absolute value of the difference between the refractive indices of the pigment material and the binder material is at least 0.1, and the coating has a solar reflectance of at least 0.94.

In a further embodiment, the pigment material comprises a semiconductor particle with a bandgap of at least 3.5 eV.

In another embodiment, the semiconductor particle is aluminum oxide, aluminum nitride, barium sulfate, calcium sulfate, or silicon oxide.

A still further embodiment also includes the pigment material comprises a semiconductor particle with an indirect bandgap of at least 3.1 eV.

In still another embodiment, the semiconductor particle is anatase titanium oxide.

In a yet further embodiment, the pigment material is in a powder form and the powder has a diameter from about 100 nm to about 3 μm.

In yet another embodiment, the powder diameters have a distribution with a standard deviation of greater than 1 μm for broadband solar scattering.

In a further embodiment again, the binder material comprises a fluoropolymer and the fluoropolymer is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), or poly(vinylidene fluoride) (PVdF).

In another embodiment again, the binder material is magnesium fluoride (MgF₂).

In a further additional embodiment, the fluoropolymer has an emittance of at least 0.8 in wavelength range from about 6 μm to about 25 μm.

In another additional embodiment, the coating has a pigment to binder volume ratio exceeding the critical pigment volume concentration to achieve at least one air void, wherein the at least one air void has a refractive index of about 1.

In a still yet further embodiment, the at least one air void has a diameter and the diameters have a distribution with a standard deviation of greater than 1 μm for broadband solar scattering.

In still yet another embodiment, the coating further comprising a second pigment material with a refractive index of less than 1.45.

In a still further embodiment again, the second pigment material is in a powder form and the second pigment material is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), poly(vinylidene fluoride) (PVdF), or magnesium fluoride (MgF₂).

In still another embodiment again, the powder has a diameter from about 100 nm to about 3 μm.

In a yet further embodiment, the powder diameters have a distribution with a standard deviation of greater than 1 μm for broadband solar scattering.

In a further embodiment again, an absolute value of the difference between the refractive indices of the two pigment materials is at least 0.1.

In another embodiment again, the binder material comprises a polymer and the polymer is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), poly(vinylidene fluoride) (PVdF), or silicone.

In a further additional embodiment, the coating has a pigment to binder volume ratio exceeding the critical pigment volume concentration to achieve at least one air void, wherein the at least one air void has a refractive index of about 1.

In another additional embodiment, the at least one air void has a diameter and the diameters have a distribution with a standard deviation of greater than 1 μm for broadband solar scattering.

In a still yet further embodiment, the binder material is water soluble and comprises at least one of fluoroethylene vinyl ether, silicone, or fluoropolymer-acrylic latexes.

In still yet another embodiment, the binder material is not water soluble and comprises poly(vinylidene fluoride) or poly(vinylidene fluoride-co-hexafluoropropene).

In still another embodiment again, the coating of further comprising at least one coalescing agent.

In a still further additional embodiment, the coalescing agent is triethyl phosphate, polyethylene glycol, or 2-Butoxyethanol.

In a further embodiment again, the coating further comprising at least one thickening agent.

In a yet further embodiment, the thickening agent is methylcellulose.

In yet another embodiment, the coating is a paint or a spray.

In a further additional embodiment, the coating is applied as a UV-reflective top coat on an UV-absorptive rutile TiO₂-based white paint.

Still another additional embodiment includes a passive daytime radiative cooling dry coating comprising: at least one pigment material, at least one binder material with a refractive index of less than 1.45, where the coating has a solar reflectance of at least 0.94, and the coating is applied as a dry coat on a substrate.

In a yet further embodiment, the pigment material is selected from the group consisting of aluminum oxide, barium sulfate, polytetrafluoroethene (PTFE), and magnesium fluoride (MgF₂).

In yet another embodiment, the binder material is selected from the group consisting of poly(vinylidene fluoride) (PVdF), fluoroethylene vinyl ether (FEVE), and poly(vinylidene fluoride-co-hexafluoropropene) (P(VdF-HFP)).

In another further embodiment, the dry coating has a pigment to binder volume ratio exceeding the critical pigment volume concentration to achieve at least one air void, wherein the at least one air void has a refractive index of about 1.

In still another further embodiment, the at least one air void has a diameter and the diameters have a distribution with a standard deviation of greater than 1 μm for broadband solar scattering.

In another further additional embodiment, the coating is applied on the substrate using a spray or an applicator.

In still yet another further embodiment, the at least one pigment material has a refractive index of greater than 1.5 and an absolute value of the difference between the refractive indices of the pigment material and the binder material is at least 0.1.

A yet further embodiment again includes the coating further comprising a second pigment material with a refractive index of less than 1.45.

In a yet further embodiment, the second pigment material is polytetrafluoroethene (PTFE), fluorinated ethylene propylene (FEP), ethylene tetrafluoroethylene (ETFE), or magnesium fluoride (MgF₂).

In still another embodiment, the dry coating has a pigment to binder volume ratio exceeding the critical pigment volume concentration to achieve at least one air void, wherein the at least one air void has a refractive index of about 1.

In a yet further embodiment, the at least one air void has a diameter and the diameters have a distribution with a standard deviation of greater than 1 μm for broadband solar scattering.

In yet another embodiment, the coating is baked at a temperature between about 60° C. and about 200° C. to yield a cohesive film.

Another further embodiment includes a method to cool an object comprising: applying at least one layer of passive radiative cooling coating on at least one surface of the object, where the passive radiative cooling coating comprises at least one pigment material with a refractive index of greater than 1.5, at least one binder material with a refractive index of less than 1.45, and at least one solvent, where the at least one binder material is soluble in the solvent, an absolute value of the difference between the refractive indices of the pigment material and the binder material is at least 0.1, and the coating has a solar reflectance of at least 0.94.

In a further embodiment, the object is an outdoor building.

In another embodiment, the pigment material comprises a semiconductor particle with a bandgap of at least 3.5 eV.

In a still further embodiment, the semiconductor particle is aluminum oxide, aluminum nitride, barium sulfate, calcium sulfate, or silicon oxide.

In still another embodiment, the pigment material comprises a semiconductor particle with an indirect bandgap of at least 3.1 eV.

In a yet further embodiment, the semiconductor particle is anatase titanium oxide.

In yet another embodiment, the pigment material is in a powder form and the powder has a diameter from about 100 nm to about 3 μm.

In a further embodiment again, the powder diameters have a distribution with a standard deviation of greater than 1 μm for broadband solar scattering.

In another additional embodiment, the binder material comprises a fluoropolymer and the fluoropolymer is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), or poly(vinylidene fluoride) (PVdF).

In a still yet further embodiment, the binder material is magnesium fluoride (MgF₂).

In still yet another embodiment, the fluoropolymer has an emittance of at least 0.8 in wavelength range from about 6 μm to about 25 μm.

In a still further embodiment again, the coating has a pigment to binder volume ratio exceeding the critical pigment volume concentration to achieve at least one air void, wherein the at least one air void has a refractive index of about 1.

In still another embodiment again, the at least one air void has a diameter and the diameters have a distribution with a standard deviation of greater than 1 μm for broadband solar scattering.

Still another additional embodiment includes the coating further comprising a second pigment material with a refractive index of less than 1.45.

In a still further additional embodiment, the second pigment material is in a powder form and the second pigment material is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), poly(vinylidene fluoride) (PVdF), or magnesium fluoride (MgF₂).

A yet further embodiment again includes the powder has a diameter from about 100 nm to about 3 μm.

Yet another embodiment again also includes the powder diameters have a distribution with a standard deviation of greater than 1 μm for broadband solar scattering.

In another further embodiment, an absolute value of the difference between the refractive indices of the two pigment materials is at least 0.1.

In yet another further embodiment, the binder material comprises a polymer and the polymer is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), poly(vinylidene fluoride) (PVdF), or silicone.

In still another further embodiment, the coating has a pigment to binder volume ratio exceeding the critical pigment volume concentration to achieve at least one air void, wherein the at least one air void has a refractive index of about 1.

In another further embodiment again, the at least one air void has a diameter and the diameters have a distribution with a standard deviation of greater than 1 μm for broadband solar scattering.

In another further additional embodiment, the binder material is water soluble, and comprises at least one of fluoropolymer, silicone, and fluoropolymer-acrylic latexes.

In still yet another further embodiment, the binder material is not water soluble, and comprises poly(vinylidene fluoride) or poly(vinylidene fluoride-co-hexafluoropropene).

Another further embodiment includes: the coating further comprising at least one coalescing agent.

In a yet further embodiment, the coalescing agent is triethyl phosphate, polyethylene glycol, or 2-Butoxyethanol.

Still another additional embodiment includes: the coating further comprising at least one thickening agent.

In a yet another embodiment, the thickening agent is methylcellulose.

In a further additional embodiment, the coating is a paint or a spray.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 illustrates passive daytime radiative cooling by solar reflection and long wave infrared thermal emission through atmospheric transmission windows in accordance with an embodiment.

FIG. 2A illustrates high solar reflectance and thermal emittance enabled passive daytime radiative cooling in accordance with an embodiment.

FIG. 2B illustrates high solar reflectance and broadband emittance of UV-reflective paint with enhanced refractive index contrast in accordance with an embodiment.

FIG. 2C illustrates broadband emittance of fluoropolymer and variants in accordance with an embodiment.

FIG. 3A illustrates the cooling power of emissive coatings as a function of solar reflectance in accordance with an embodiment.

FIG. 3B illustrates broadband emitters have better cooling performances as selective emitters at near and above ambient temperature conditions in accordance with an embodiment.

FIG. 3C illustrates broadband emitters have similar cooling performances as selective emitters under desert sky conditions in accordance with an embodiment.

FIG. 3D illustrates broadband emitters have similar cooling performances as selective emitters under tropical sky conditions in accordance with an embodiment.

FIG. 4A illustrates scattering efficiency of pigment materials as a function of refractive index of surround media in accordance with an embodiment.

FIG. 4B illustrates scattering efficiency of pigment particles as a function of particle size distribution in accordance with an embodiment.

FIG. 5A illustrates the coloration of acrylic adhesive film and fluoropolymer based coating under UV exposure in accordance with an embodiment.

FIG. 5B illustrates fluoropolymers and silicone have lower UV absorptances than acrylic in accordance with an embodiment.

FIGS. 6A-6F illustrate the spectral reflectance of paints of about 1 millimeter thick based on rutile TiO₂, Al₂O₃, BaSO₄, porous P(VdF-HFP) and PTFE, and silvered polymers, in accordance with an embodiment.

FIG. 7 illustrates the solar reflectance of paints and silvered plastics in accordance with an embodiment.

FIG. 8 illustrates long wave infrared emittance of building materials, paints and silvered emitters in accordance with an embodiment.

### DETAILED DESCRIPTION OF THE INVENTION

Turning now to the drawings, methods and systems for producing UV-reflective coatings for passive cooling are described. Many embodiments provide coatings with a high overall solar reflectance and a high thermal emittance for passive daytime radiative cooling. Several embodiments provide that coatings with solar-ultraviolet (UV) reflectance can lead to a high overall solar reflectance. In many embodiments, the coatings can be in a form including (but not limited to): paint and spray. Several embodiments provide that the coatings are dry coatings. Coating materials with passive radiative cooling properties have a high solar (wavelength from about 0.3 μm to about 2.5 μm) reflectance and a high radiative thermal emittance. Many embodiments implement broadband emitters and/or selective long wave infrared (LWIR) emitters in coatings. In several embodiment, coating materials can be a broadband emitter (wavelength from about 2.5 μm to about 40 μm) with a high solar reflectance. In a number of embodiments, coating materials can be a selective LWIR (wavelength from about 8 μm to about 13 μm) emitter with a high solar reflectance. High solar reflectance coating materials can minimize solar heating in accordance with some embodiments. High broadband emittance coating materials (emitting over wavelength from about 6 μm to about 25 μm), encompassing the LWIR wavelengths, can maximize radiative heat loss to space in accordance with several embodiments. Some embodiments implement coatings with a high solar reflectance and a high radiative thermal emittance and/or LWIR emittance onto at least one surface that is under the sky. Solar heating can be outweighed by radiative heat loss to outer space, thus the surface spontaneously cools, even under strong sunlight, in accordance with several embodiments.

In many embodiments, broadband emitters (emitting over wavelengths from about 2.5 μm to about 40 μm) are better suited for radiative cooling than selective LWIR emitters. In several embodiments, broadband emitters can take advantage of the small atmospheric transmittance window that opens in arid regions where the atmosphere has a lower humidity. In several embodiments, broadband emitters are better suited for cooling at near and/or above-ambient temperatures. In several embodiments, the binder polymers including (but not limited to) fluoropolymers and their variants have a high broadband emittance. In certain embodiments, the pigment materials embedded in the emissive binder polymers can scatter and increase the optical path length of thermal radiation, further enhancing the broadband emittance.

Many embodiments provide compositions and/or composition materials of effective radiative cooling coatings. Some embodiments provide coatings with a high solar reflectance. In several embodiments, coatings with high solar reflectance have high UV reflectance as well, as there is about 6% of solar intensity that lies in the ultraviolet range. Certain embodiments achieve solar reflectance of at least 0.94. In some embodiments, solar reflectance can range from about 0.94 to about 0.98. Several embodiments remove sources of solar absorption to enhance solar reflectance. Some embodiments implement material alterations to improve solar reflectance of UV-reflective paints. Certain embodiments implement the replacement of conventional paint materials such as rutile titanium oxide (TiO₂) with pigment materials that have better UV-non absorptive properties.

Many embodiments provide that coating composition materials with low and high refractive indexes (n) in the solar wavelengths can maximize refractive index contrast across constituents of the coatings, enhancing the scattering of UV and other solar wavelengths and hence enhancing reflectance. Some embodiments include coating composition materials with high refractive index of at least 1.5. Examples of high refractive index coating composition materials include (but are not limited to): barium sulfate, aluminum oxide, calcium sulfate, aluminum nitride, and anatase titanium oxide. In many embodiments, high refractive index materials can be used as pigment materials in effective radiative cooling coatings. A number of embodiments include coating composition materials with low refractive index of less than 1.45. Examples of low refractive index coating composition materials include (but are not limited to): polytetrafluoroethene (PTFE), fluorinated ethylene propylene (FE P), ethylene tetrafluoroethylene (ETFE), magnesium fluoride, poly(vinylidene fluoride-co-hexafluoropropene) (PVdF-HFP), polyvinylidene fluoride (PVdF), fluoroethylene vinyl ether (FEVE), and silicone. In many embodiments, low refractive index materials can be used as pigment materials and binder materials in effective radiative cooling coatings. In several embodiments, refractive index contrast (Δn, the refractive index difference) of the mixture composition materials is greater than 0.1. Certain embodiments implement that the absolute value of the refractive index contrast (Δn) of the mixture composition materials is greater than 0.1.

Many embodiments implement at least one pigment material in coating materials that have high solar reflectance. Properties of the pigment materials can include (but are not limited to): high solar reflectance, high UV reflectance, and non-UV absorptive. Examples of pigment materials can include (but are not limited to): semiconductor particles with wide bandgaps, semiconductor particles with indirect bandgaps, and non-semiconductor materials. Some embodiments implement semiconductor particles with wide bandgaps of at least 3.5 eV in UV-reflective paints. Certain embodiments implement semiconductor particles with indirect bandgap of at least 3.1 eV in UV-reflective paints. Examples of semiconductor particles include (but are not limited to): aluminum oxide, Al₂O₃ (bandgap at about 7.0 eV), barium sulfate, BaSO₄ (bandgap at about 6.0 eV), calcium sulfate, CaSO₄ (bandgap at about 6.0 eV), aluminum nitride, AlN (bandgap at about 6.0 eV), and anatase (a titanium dioxide variant). Some embodiments implement UV-reflective paints pigments with polymeric materials including (but not limited to) fluoropolymer powder pigments. In certain embodiments, the polymer materials in UV-reflective paints have minimal absorptance in the solar wavelengths (from about 0.3 μm to about 2.5 μm). Examples of the fluoropolymer powders include (but are not limited to): ethylene tetrafluoroethylene (ETFE), fluorinated ethylene propylene (FEP), fluoroethylene vinyl ether (FEVE), polyvinylidene fluoride, poly(vinylidene fluoride-co-hexafluoropropene) (PVdF-HFP), and polytetrafluoroethene (PTFE). In certain embodiments, poly(vinylidene fluoride-co-hexafluoropropene) can be referred as poly(vinylidene fluoride-co-hexafluoropropylene).

Several embodiments provide that the pigment materials are in a powder form. The pigment powder materials have diameters from about 100 nm to about 3 μm in accordance with some embodiments. The powder diameters have a wide size distribution with a standard deviation of greater than 1 μm for broadband solar scattering.

In many embodiments, pigment materials with low and high refractive indexes (n) in the solar wavelengths can maximize refractive index contrast across constituents of the coatings, enhancing the scattering of UV and other solar wavelengths by the pigments, and hence enhancing reflectance. Some embodiments include materials with high refractive index of at least 1.5. Certain embodiments include materials with high refractive index of at least 2. A number of embodiments include materials with low refractive index of less than 1.45. In several embodiments, refractive index contrast (Δn, the refractive index difference) of the mixture pigment material is greater than 0.1. Certain embodiments implement that the absolute value of the refractive index contrast (Δn) of the mixture pigment material is greater than 0.1. In some embodiments, pigment material mixture can include at least one high refractive index material including (but not limited to): BaSO₄, Al₂O₃, CaSO₄, AlN and anatase TiO₂. In several embodiments, pigment material mixture can include at least one low refractive index material including (but not limited to): PTFE, FEP, ETFE, polyvinylidene fluoride (PVdF), PVdF-HFP, magnesium fluoride.

Some embodiments implement a mixture of at least one UV-reflective pigment material and at least one air void (n of about 1) to maximize refractive index contrast and enhance reflection in the solar wavelengths. Several embodiments employ a mixture with a high pigment to polymer binder volume ratio. Beyond a certain volume ratio threshold, known as the critical pigment volume concentration, the low volume of polymer binder insufficiently penetrates the space between pigments and enables voids containing air to form, which can enhance refractive index contrast and thus reflectance in accordance with many embodiments. In several embodiments, the air voids have diameters with a standard deviation of greater than 1 μm for broadband solar scattering.

Many embodiments implement at least one binder material in coating materials that have high solar reflectance. In several embodiments, the binder can be a polymer binder material. Polymer binders in accordance with some embodiments may have low to negligible UV absorptivity, low near infrared (NIR) absorptivity, and/or low-refractive index. Many embodiments provide various applications of coatings including (but not limited to): non-aqueous coatings and aqueous coatings. In some embodiments, binder materials for non-aqueous coatings include (but are not limited to): poly(vinylidene fluoride), (P(VdF)), and poly(vinylidene fluoride-co-hexafluoropropylene), (P(VdF-HFP)). In several embodiments, binder materials for aqueous coatings including (but not limited to) paintable coating include (but are not limited to): water-based dispersions of fluoropolymer, fluoroethylene vinyl ether (FEVE), silicone, and fluoropolymer-acrylic latexes. Certain embodiments implement fluoropolymers with low absorption in the solar, particularly the solar-infrared wavelengths. A number of embodiments include low refractive index materials in binder materials. Examples of low refractive index (n) binder materials include (but are not limited to): PVdF (n of about 1.42), FEVE (n of about 1.43), and P(VdF-HFP) (n of about 1.40).

Many embodiments provide various high refractive index materials and/or low refractive index materials as pigment materials in effective radiative cooling coatings. Several embodiments provide low index materials as pigment materials and/or binder materials in effective radiative cooling coatings. In some embodiments, the high refractive index pigment material and the low refractive binder material have an absolute value of the refractive index contrast (Δn) greater than 0.1. Certain embodiments mix the high refractive index pigment material and the low refractive index pigment material together, and the mixed pigment materials have an absolute value of the Δn greater than 0.1. In many embodiments, the high and/or low refractive index pigment materials, and the low refractive index binder materials are mixed with air voids. Several embodiments provide that the pigment materials and the air voids have an absolute value of the Δn greater than 0.1. Some embodiments provide that the binder materials and the air voids have an absolute value of the Δn greater than 0.1. Table 1 lists refractive indices of pigment and binder materials in accordance with some embodiments. In certain embodiments, high index materials that can be implemented as pigment materials include (but are not limited to): Al₂O₃ (n of about 1.7), BaSO₄ (n of about 1.6), CaSO₄ (n of about 1.5), AlN (n greater than 2.0), and anatase TiO₂ (n greater than 2.0). In a number of embodiments, low index materials that can be implement as pigment and/or binder materials include (but are not limited to): PTFE (n of about 1.35), FEP (n of about 1.34), ETFE (n of about 1.40), magnesium fluoride (n of about 1.38), air (n of about 1), P(VdF-HFP) (n of about 1.40), PVdF (n of about 1.42), FEVE (n of about 1.43), and silicone (n between about 1.42 and about 1.45).

TABLE 1
Table of Refractive Indices

| High index material (pigment) | Low Index Material (pigment or binder) |
|---|---|
| BaSO₄ (n of about 1.6) | PTFE (n of about 1.35) |
| Al₂O₃ (n of about 1.7) | FEP (n of about 1.34) |
| CaSO₄ (n of about 1.5) | ETFE (n of about 1.40) |
| TiO₂ (anatase) | Magnesium fluoride |
| (n greater than about 2) | (n of about 1.38) |
| AlN (n greater than about 2) | Air (n of about 1) |
| | P(VdF-HFP) (n of about 1.40) |
| | PVdF (n of about 1.42) |
| | FEVE (n of about 1.43) |
| | Silicone (n of about 1.42-1.45) |

Many embodiments provide that pigment materials mixed with fluoropolymer and/or fluoropolymer variants have a higher solar scattering efficiency than mixing with acrylic. Fluoropolymer binders and/or their variants have lower refractive indices (n from about 1.38 to about 1.43) compared to acrylic (n of about 1.495). Pigment materials with high refractive index embedded in fluoropolymers and/or their variants have a higher solar scattering efficiency than those embedded in acrylic in accordance with several embodiments. Many embodiments include that silicone has a lower refractive index than acrylic. In several embodiments, mixing pigment materials with silicone can enhance reflectance of the paint.

In many embodiments, solar absorptance can be lowered by reducing the amount of polymer in the paint. Reducing the amount of polymer relative to the pigment below a certain threshold can lead to the formation of voids in the paint film in accordance with some embodiments. The presence of voids can increase the refractive index contrast between the pigments and the surrounding environment, further enhancing solar reflectance.

Many embodiments implement additional materials in coating materials that have high solar reflectance. Examples of additional materials include (but are not limited to): a coalescing agent and a thickening agent. Coalescing agents can include (but are not limited to): triethyl phosphate, polyethylene glycol, and 2-Butoxyethanol. Examples of thickening agents include (but are not limited to) methylcellulose.

### Passive Daytime Radiative Cooling

Passive cooling technologies provide a sustainable alternative to active cooling methods. Passive daytime radiative cooling (PDRC) involves the spontaneous reflection of sunlight and radiation of long wave infrared (LWIR) heat through respective atmospheric transmission windows into outer space. The wavelength λ of sunlight ranges from about 0.3 μm to about 2.5 μm, while the wavelength λ of LWIR ranges from about 8 μm to about 13 μm. When a surface under the sky has a sufficiently high solar reflectance Rₛₒₗₐᵣ, and LWIR emittance ϵ_{LWIR}, solar heating can be outweighed by radiative heat loss to outer space, thus the surface spontaneously cools, even under strong sunlight. The passive operation and net cooling effect may overcome two major limitations of active cooling methods. Since buildings exchange large amounts of heat with their environment as radiation, this makes PDRC attractive for cooling buildings.

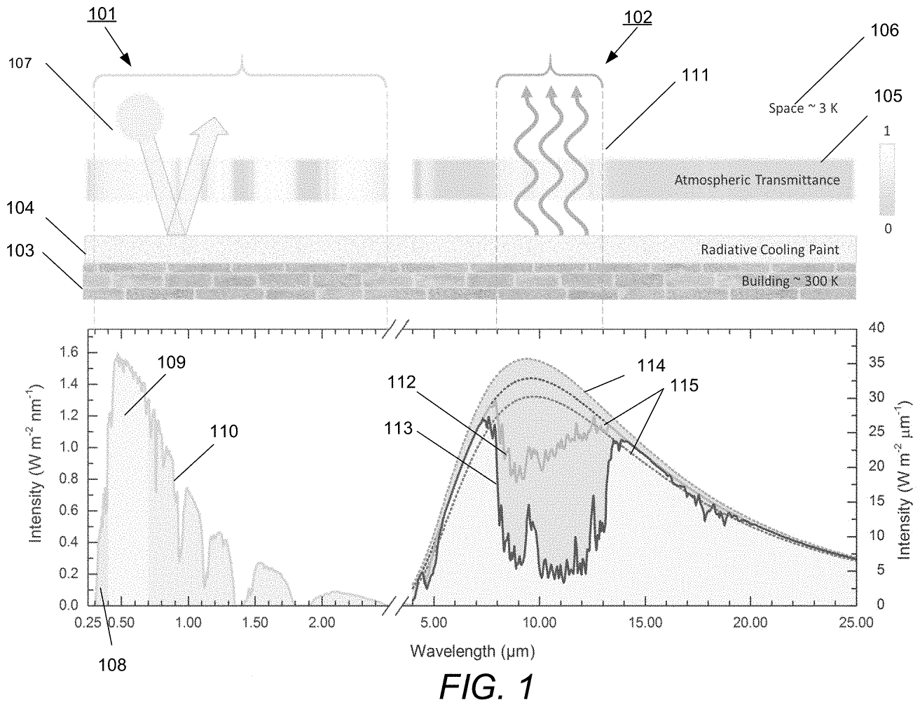

A schematic showing passive daytime radiative cooling by solar reflection and LWIR thermal emission through the atmospheric transmission windows in accordance with an embodiment of the invention is illustrated in FIG. 1. In FIG. 1, the process of sunlight reflected back into space (101) is illustrated. A layer of radiative cooling paint (104) coats the outer surface of a building (103). The building (103) can be at a temperature of about 300 K. The sunlight (107) transmits through the space (106) and reflects from the radiative cooling paint (104) and back into the space (106). The space (106) can be at a temperature of about 3 K. The atmospheric transmittance (105) illustrates the radiation transmitted by the atmosphere and varies by wavelength. The wavelength of sunlight ranges from about 0.3 μm to about 2.5 μm. The solar spectrum comprises about 6% UV (108), about 42% visible light (109), and about 52% near infrared (NIR) light (110). The sunlight can have an intensity of about 1000 Wm⁻².

In FIG. 1, the process of LWIR radiated back into space (102) is illustrated. The LWIR radiation (111) emits from the radiative cooling paint (104) and through the space (106). The wavelength of sunlight ranges from about 8 μm to about 13 μm. The downwelling heat from tropical sky is illustrated in 112 and the downwelling heat from desert sky is illustrated in 113. The radiated heat from perfect emitters at near (±5° C.) is illustrated in 114 and radiated heat from perfect emitters at ambient temperatures (about 30° C.) is illustrated in 115. The cooling potential of selective LWIR emitters is the difference between the radiated heat from emitters and the downwelling heat. LWIR emission has cooling potential of about 10 to 150 Wm⁻².

Radiative cooling has a history with materials like polymers including polymethylpentene (TPX) and polyvinyl fluoride (PVF)), dielectrics including silicon oxide (SiO_{X}) and zinc selenide (ZnSe), polymer composites, and paints (See, e.g. Zeyghami, M., et al., Solar Energy Mater. And Solar Cells, 2018, 178, 115-128; and Sun, X., et al., Nanophotonics, 2017, 6, 997-1015, the disclosures of which are incorporated herein by reference). Radiative cooling technology has seen a revival with enhancements of earlier architectures and new photonic and polymeric designs. (See, e.g. Gentle, A. R., et al., Nano Lett., 2010, 10, 373-379; Zhai, Y., et al., Science, 2017, 355, 1062-1066; Raman, A. P., Nature, 2014, 515, 540-544; and Mandal, J., et al., Science, 2018, 362, 315, the disclosures of which are incorporated herein by reference). While these materials can be efficient at cooling, their utility may depend on the application. For instance, photonic stacks, which are sophisticated but have a high Rₛₒₗₐᵣ and selective ϵ_{LWIR}, cool to deep sub-ambient temperatures, and can be used in water-cooled HVAC systems, refrigerators and thermoelectric devices. A broad application of PDRC, however, is cooling buildings and other outdoor structures.

Overmeer et al. (Overmeer, Q. V., et al., U.S. Pat. No., 10,323,151, the disclosure of which is incorporated herein by reference) has disclosed a passive radiative cooling coating that includes non-absorbing polymer layers. The polymer layers may include TiO₂ as pigment materials. Used in paint, TiO₂ pigment materials may cause UV absorption, lower total solar reflectance, and reduce radiative cooling capability under sunlight. Overmeer et al. also uses a fluoropolymer layer as a top-coat on top of the non-absorbing polymer layers, instead of mixing the fluoropolymer with the pigment and binder materials in a solvent as the non-absorbing polymer layers.

Ruan et al. (Ruan X. L., et al., PCT Patent App. No., WO 2020/072818, the disclosure of which is incorporated herein by reference) has disclosed a metal free solar reflective infrared emissive paint that uses semiconductor pigment materials in the paint. Ruan et al. discloses the use of acrylic as the polymer binder material in the paint. However, Ruan et al. does not use fluoropolymer as the pigment material or the polymer binder material. In addition, Ruan et al. does not discuss the optical properties (for example, refractive indices) of the materials or the selection of the materials based on their optical properties would matter to the cooling effect of the paint. Ruan et al. does not include an aqueous system for the paint materials.

Despite their potential, practical requirements for radiative cooling building envelopes may restrict their use. For general use, a PDRC building envelope would be: applicable on surfaces with various shapes, sizes, and textures; resistant to ambient chemicals, solar irradiation, and the weather; and affordable and accessible in different socioeconomic environments, particularly in the developing world. A PDRC technology for buildings should therefore be sufficiently versatile, inexpensive, durable and scalable, while still being effective at cooling. Having co-evolved with buildings, paints readily fulfil the practical requirements, and are one of the modest radiative coolers. White “cool-roof” paints, which have a modest Rₛₒₗₐᵣ at about 0.8 and a high ϵ_{LWIR} at about 0.95, are already used for cooling buildings, enhancements in Rₛₒₗₐᵣ would make the paints become near-optimal for PDRC. Along with their scalability, this can make paints ideal for cooling buildings.

Many embodiments implement PDRC of buildings with UV-reflective coatings including paints and provide effective methods to achieve passive cooling on a large scale. While reflective coatings on buildings reduce solar heating, PDRC technologies can achieve heat loss even under sunlight, potentially doubling the cooling energy savings in buildings. Many embodiments provide PDRC building envelopes with a high Rₛₒₗₐᵣ to minimize solar heating and a high ϵ_{LWIR} to maximize radiative heat loss to space.

In several embodiments, broadband thermal emitter can achieve similar cooling effect as selective LWIR emitters in emissive coatings. Previous radiative cooling technologies (see, e.g., Hossain, M. M., et al., Adv. Sci., 2016, 3, 1500360, the disclosure of which is incorporated herein by reference) emphasize the need for selective LWIR emittance (wavelengths from about 8 μm to about 13 μm) to maximize cooling for achieving deep sub-ambient temperatures. Building envelopes, on the other hand, are typically at near- or above-ambient temperatures due to their contact with air, exposure to sunlight, and heat generation indoors. Ambient temperatures refer to the temperature of ambient outdoor air in accordance with some embodiments. Sub-ambient temperatures refer to temperatures below the temperature of ambient outdoor air. Near- or above-ambient temperatures refer to temperatures near—or above—the temperature of ambient outdoor air. In many embodiments, broadband emitters have a higher radiative cooling potential than selective emitters at near- or above-ambient temperatures, and thus are better at losing heat and cooling. Forced convection by moving air, and heat generation within buildings, can bring the temperatures of building envelopes close to ambient temperatures. In tropical regions, a combination of high solar irradiance and high humidity which impedes radiative cooling, can even lead to above ambient temperatures for radiative coolers. In many embodiments, broadband emitters (emitting over wavelengths from about 2.5 μm to about 40 μm) are more desirable for radiative cooling than selective LWIR emitters. In some embodiments, long term degradation and temporary soiling of building envelopes reduces solar reflectance to levels where solar heating can lead to above-ambient temperatures, making a broadband emittance better suited for cooling. In several embodiments, broadband emitters can take advantage of the small atmospheric transmittance window that opens in arid regions where the atmosphere has a lower humidity, and achieve greater cooling. Many embodiments provide broadband thermal emittance subtending the LWIR wavelengths that is as effective at cooling as a selective LWIR emittance. Broadband emitters in accordance with many embodiments can broaden material selections for coatings, as most non-metallic materials intrinsically exhibit high, broadband emissivity.

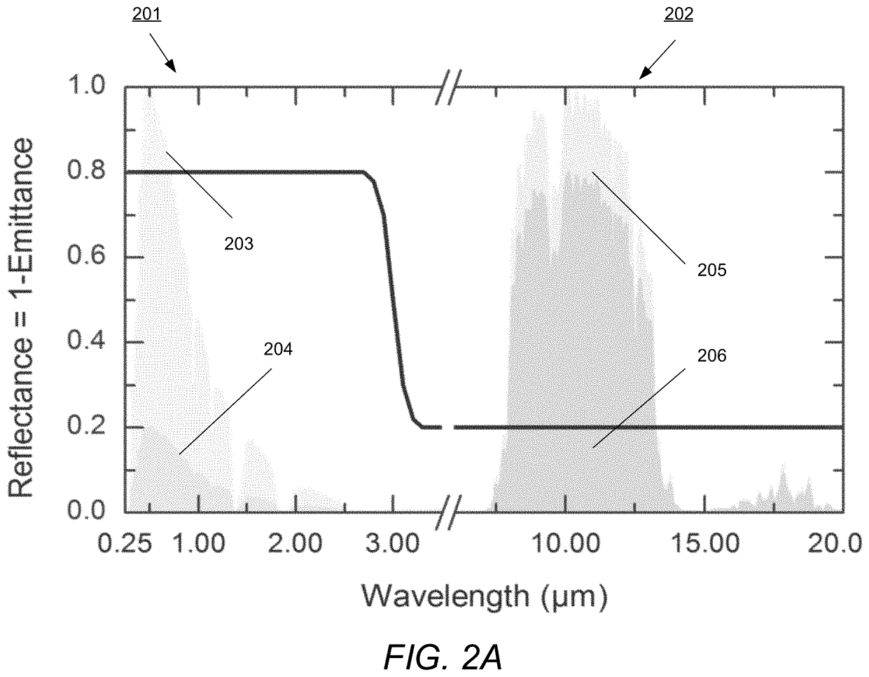

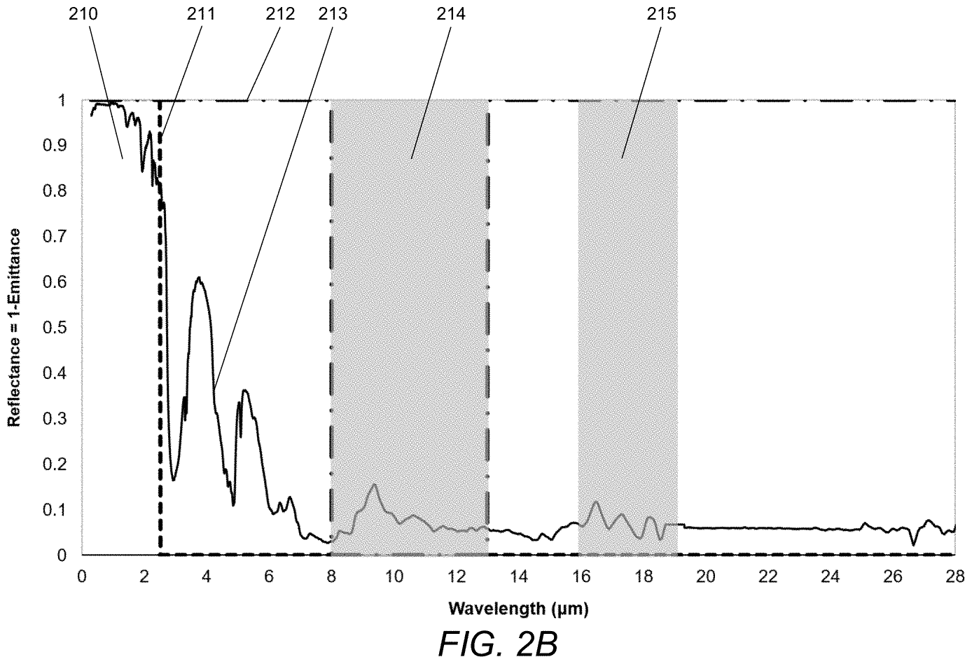

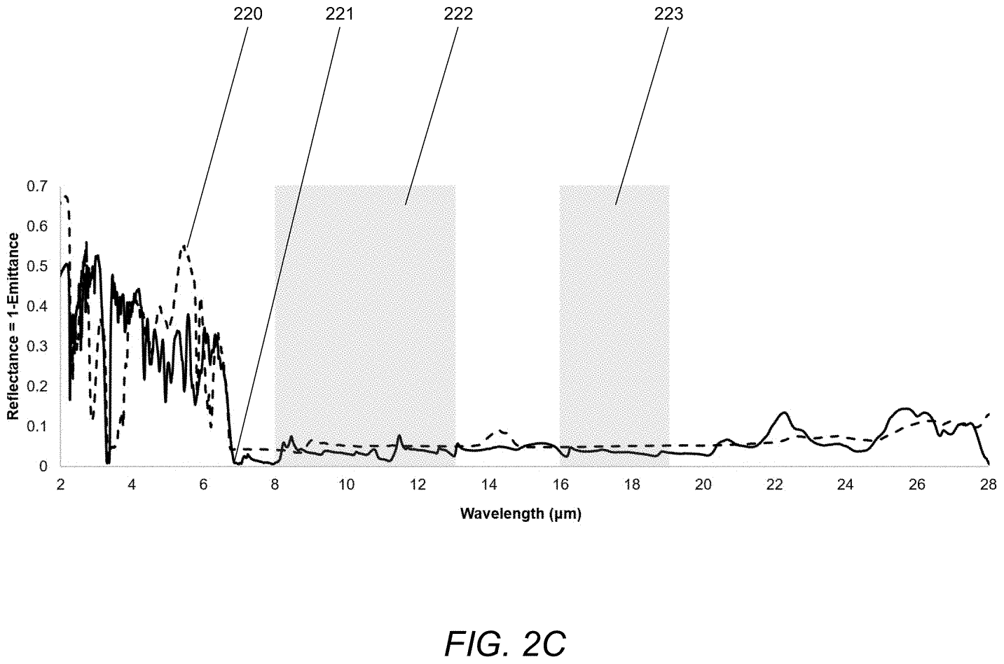

A schematic showing high solar reflectance and thermal emittance enabling PDRC in accordance with an embodiment of the invention is illustrated in FIG. 2A. Solar reflectance is illustrated in wavelength ranges from about 0.3 μm to about 2.5 μm (201). Solar reflectors with high solar reflectance in accordance with some embodiments have solar reflectance of at least 0.8. A higher solar reflectance (203) can reduce solar absorption (204). Thermal emittance is illustrated in wavelength ranges from about 8 μm to about 20 μm (202). Thermal emitters with high emittance in accordance with several embodiments have emittance of at least 0.8. Higher emittance (205) can increase LWIR heat loss (206). At near-ambient temperatures, radiative transfer equals to ‘radiated heat from emitter’ subtracts ‘downwelling heat from sky’. The radiative transfer at near-ambient temperatures is small outside the LWIR window, making broadband and selective LWIR emitters similarly effective at cooling.

Many embodiments implement broadband emitters to achieve better radiative cooling efficiency. Several embodiments enhance radiative cooling efficiency by enhancing refractive index contrast. In some embodiments, high and low refractive index pigment materials and/or binder materials can be combined to achieve a greater refractive index contrast. In some embodiments, coating can include at least one high refractive index material including (but not limited to): BaSO₄, Al₂O₃, CaSO₄ and anatase TiO₂. In several embodiments, coating can include at least one low refractive index material including (but not limited to): PTFE (n of about 1.35), FEP (n of about 1.34), ETFE (n of about 1.40), magnesium fluoride (MgF₂, n of about 1.38), P(VdF-HFP) (n of about 1.40), and PVdF (n of about 1.42) and FEVE (n of about 1.43). Some embodiments provide that MgF₂ and/or PTFE can be used as pigment materials in the coating. A number of embodiments provide that ETFE, FEVE, PVdF and P(VdF-HFP) can be used as pigment materials and/or binder materials. In certain embodiments, powder form of ETFE, FEVE, PVdF and P(VdF-HFP) can be used as pigment materials.

A schematic showing radiative cooling coating with high solar reflectance and broadband emittance of enhanced refractive index contrast UV-reflective paint in accordance with an embodiment of the invention if illustrated in FIG. 2B. An ideal broadband radiative cooler (211) has high emittance (low reflectance) in broadband wavelength ranges from about 2.5 μm to about 28 μm. An ideal selective LWIR radiative cooler (212) has high emittance (low reflectance) in LWIR wavelength ranges from about 8 μm to about 13 μm. A UV-reflective paint (213) shows about 98% solar reflectance (210). The UV-reflective paint is a mixture of a high refractive index material barium sulfate (with additives) and a low refractive index material PVdF-HFP. The UV-reflective paint (213) shows high broadband emittance between wavelength 2.5 μm and 28 μm. In the LWIR atmospheric transparency window (214) between wavelength 8 μm and 13 μm, the paint (213) shows greater than 90% broadband thermal emittance. In the mini atmospheric transparency window in arid regions (215) between wavelength 16 μm and 19 μm, the paint (213) shows a high broadband emittance.

A schematic showing broadband thermal emittance of fluoropolymer variants in accordance with an embodiment of the invention is illustrated in FIG. 2C. Both FEVE resin on metal substrate (220) and PVdF on metal (221), representative of fluoropolymer-based variants, have high, intrinsic broadband emittance across the thermal infrared wavelengths between 3 μm and 28 μm. Both fluoropolymer variants have high broadband emittance in the LWIR atmospheric transparency window (222) and the mini transparency window present in arid regions (223).

Many embodiments provide that raising the Rₛₒₗₐᵣ of emissive coatings can achieve better PDRC effects. In some embodiments, the increase of Rₛₒₗₐᵣ into radiative coolers that continuously lose heat to the sky regardless of the time of day can reduce cooling loads of buildings.

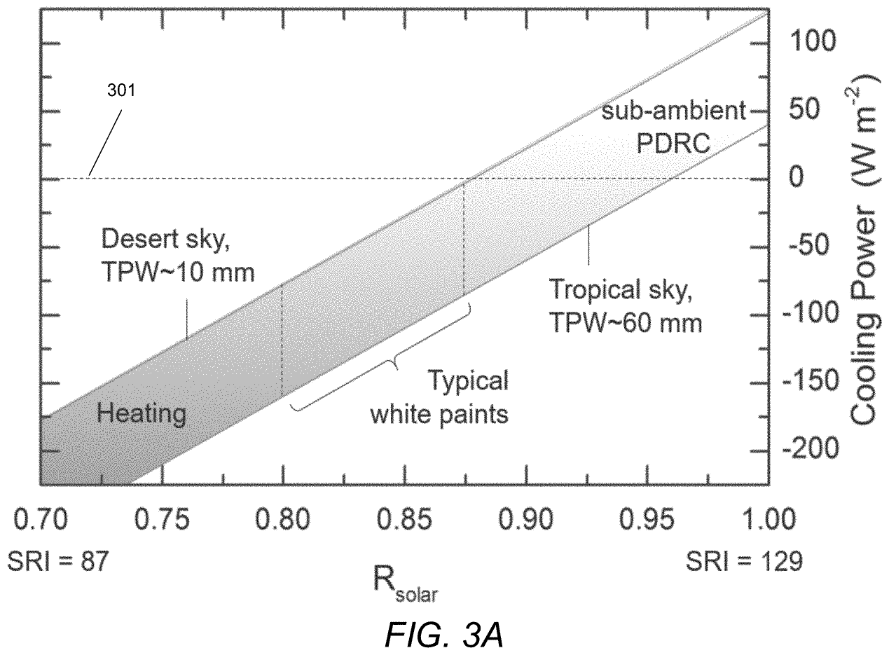

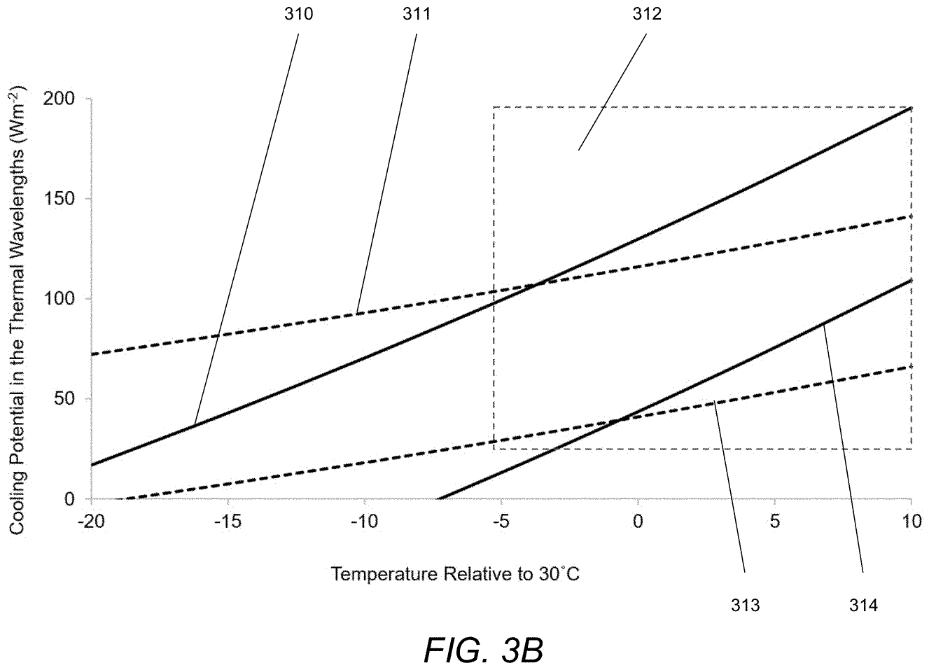

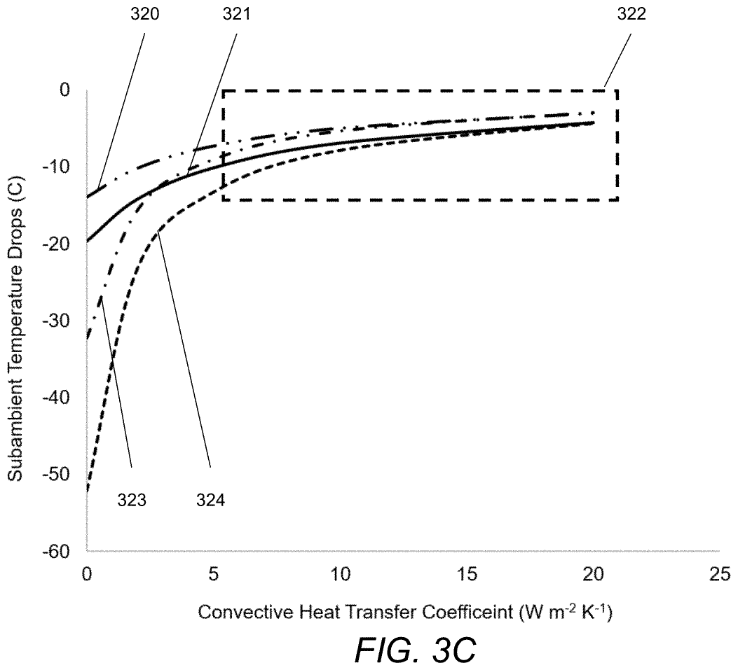

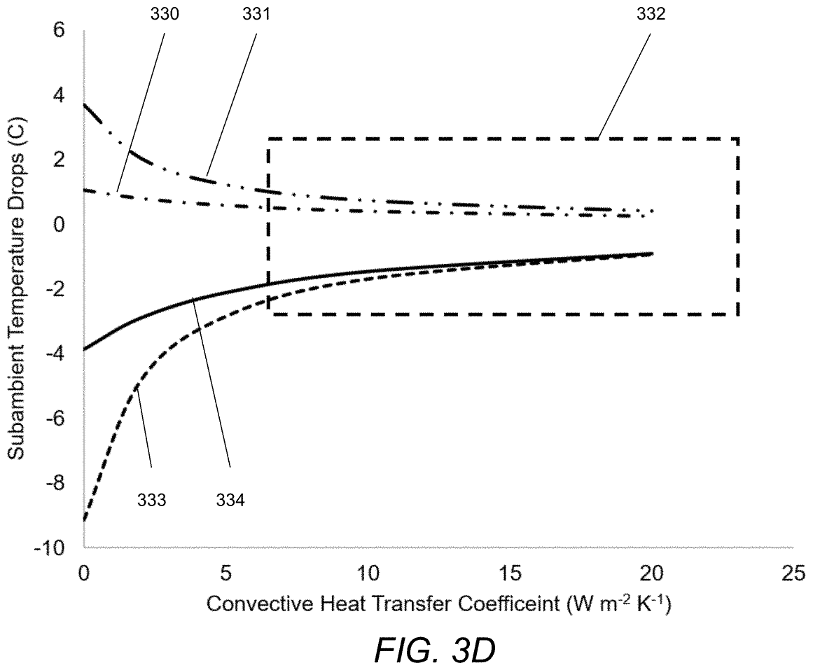

A schematic showing cooling powers of emissive coatings as a function of solar reflectance in accordance with an embodiment of the invention is illustrated in FIG. 3A. Cooling powers can be calculated by subtracting ‘solar absorption’ from ‘thermal emission’ of emissive coatings. In FIG. 3A, selective LWIR emitter has emissivity ϵ_{LWIR} of about 0.95. The temperature is about 30° C., and solar intensity is about 1000 Wm⁻². Solar reflectance Rₛₒₗₐᵣ ranges from about 0.7 to about 1. To achieve sub-ambient radiative cooling (cooling power at about 0 Wm⁻², 301), Rₛₒₗₐᵣ is about greater than 0.95. With Rₛₒₗₐᵣ less than 0.95, the emissive coatings may be able to keep coated surfaces cooler than uncoated ones, but do not yield sub-ambient cooling under strong sunlight.

In many embodiments, broadband emitters have better cooling performance as selective LWIR emitters at near and/or above ambient temperatures. A schematic of cooling potential in the thermal wavelengths for an ideal broadband emitter in desert conditions and tropical conditions, an ideal selective emitter in desert conditions and tropical conditions, in accordance with an embodiment of the invention is illustrated in FIG. 3B. Cooling potential in the thermal wavelengths is also known as infrared cooling potential. Cooling potential of an ideal broadband emitter in desert conditions (310), an ideal selective emitter in desert conditions (311), an ideal broadband emitter in tropical conditions (314), and an ideal selective emitter tropical conditions (313) are shown. At near or above ambient temperatures (312), a broadband emitter (310) shows better cooling potential than a selective emitter (311) in desert conditions. At near or above ambient temperatures (312), a broadband emitter (314) shows better cooling potential than a selective emitter (313) in tropical conditions.

In many embodiments, broadband emitters have similar cooling performance as selective LWIR emitters at near and/or above ambient temperatures. A schematic of sub-ambient temperatures of ideal broadband and selective radiative coolers under desert sky and different heat gain coefficients in accordance with an embodiment of the invention is illustrated in FIG. 3C. In FIG. 3C, ambient temperature is set at around 30° C. The convective heat transfer coefficient at around 0 W m⁻² K⁻¹ is equivalent of vacuum environment. The convective heat transfer coefficient at around 5 W m⁻² K⁻¹ is equivalent of still air in closed spaces. The convective heat transfer coefficient at around 10 W m⁻² K⁻¹ is equivalent of near-still air in open spaces. The convective heat transfer coefficient at around 20 W m⁻² K⁻¹ is equivalent of mild breeze environment. Typical operating conditions for building envelopes is convective heat transfer coefficient between about 10 W m⁻² K⁻¹ and about 20 W m⁻² K⁻¹. The sub-ambient temperature drops under desert sky of a broadband radiative cooler with solar reflectance of about 0.98 (321), a selective LWIR radiative cooler with solar reflectance of about 0.98 (324), a broadband radiative cooler with solar reflectance of about 0.95 (320), and a selective LWIR radiative cooler with solar reflectance of about 0.95 (323) are shown. Under typical operating conditions for building envelopes, there is minimal temperature difference between broadband and selective LWIR emitters (322) under desert sky conditions. Both broadband and selective emitters are close to ambient temperatures.

A schematic of sub-ambient temperatures of ideal broadband and selective radiative coolers under tropical sky and different heat gain coefficients in accordance with an embodiment of the invention is illustrated in FIG. 3D. In FIG. 3D, ambient temperature is set at around 30° C. The convective heat transfer coefficient at around 0 W m⁻² K⁻¹ is equivalent of vacuum environment. The convective heat transfer coefficient at around 5 W m⁻² K⁻¹ is equivalent of still air in closed spaces. The convective heat transfer coefficient at around 10 W m⁻² K⁻¹ is equivalent of near-still air in open spaces. The convective heat transfer coefficient at around 20 W m⁻² K⁻¹ is equivalent of mild breeze environment. Typical operating conditions for building envelopes is convective heat transfer coefficient between about 10 W m⁻² K⁻¹ and about 20 W m⁻² K⁻¹. The sub-ambient temperature drops under tropical sky of a broadband radiative cooler with solar reflectance of about 0.98 (334), a selective LWIR radiative cooler with solar reflectance of about 0.98 (333), a broadband radiative cooler with solar reflectance of about 0.95 (330), and a selective LWIR radiative cooler with solar reflectance of about 0.95 (331) are shown. Under typical operating conditions for building envelopes, there is minimal temperature difference between broadband and selective LWIR emitters (332) under tropical sky conditions. Both broadband and selective emitters are close to ambient temperatures.

### Passive Daytime Radiative Cooling Capabilities of Paints

White “cool-roof” paints have been established as a mature, scalable and durable technology for cooling buildings, covering dark roofs (Rₛₒₗₐᵣ at about 0.3) with such paints (Rₛₒₗₐᵣ at about 0.8) can yield electricity savings of about 5 kWh m⁻² yr⁻¹ in hot climates. However, the radiative cooling ability of such technology can be limited. Morphologically, paints are composites comprising optical scatterers, typically dielectric pigments, embedded in a polymer. A typical white paint contains TiO₂ pigments dispersed in acrylic or silicone in an about 50 to 50 mass ratio, with additional fillers like SiO₂ and CaCO₃. These intrinsically emissive materials are well-known thermal emitters, and impart a near-unity, broadband, emittance e of about 0.95 on paints. The emissivity of typical paints are on par, or even higher than, broadband emitters, making paints efficient at radiating heat into space.

The cooling performance of traditional white coatings may suffer from material limitations. Rutile TiO₂ and ZnO pigments typically used in white coatings can strongly absorb ultraviolet light. Certain polymer binders in white coatings, such as some acrylics, also contain UV-absorptive chromophores. Consequently, traditional paints containing such materials may not be able to achieve a reflectivity above 0.94. Typically, the reflectivity of traditional paints is lower than 0.9. The resultant solar absorption can significantly reduce their cooling performance, particularly in tropical regions, where heat loss by radiation in the wavelength between about 8 μm to about 13 μm may be difficult.

The solar reflectance Rₛₒₗₐᵣ of paints can be lower than those of silver-based PDRC designs. The lower Rₛₒₗₐᵣ of paints may be due to the conventional use of rutile TiO₂ as the white pigment. The Rₛₒₗₐᵣ of the silver-based PDRC ranges from about 0.92 to about 0.97. The refractive index (n) of the rutile TiO₂ nanoparticles is greater than 2.5, and is higher relative to that of polymer binders (refractive index is about 1.5). This property of the rutile TiO₂ nanoparticles can enable them to scatter sunlight more effectively than the same amount of other white pigments, making it cost effective. However, due to its bandgap at about 3.0 eV (wavelength λ at about 413 nm), rutile TiO₂ intrinsically absorbs ultraviolet light (UV, wavelength λ from about 300 nm to about 400 nm) and violet light (wavelength λ from about 400 nm to about 410 nm), which carries about 7% of solar energy. This may restrict Rₛₒₗₐᵣ to be less than about 0.95. Effort has been made to optimize TiO₂ particle sizes to increase scattering and approach the Rₛₒₗₐᵣ limit. However, near-infrared (NIR) solar absorption by polymer binders and non-unity reflectance at other wavelengths means that even with optimization, Rₛₒₗₐᵣ of such materials has a realistic limit of about 0.92 and is less than about 0.86 for the rutile TiO₂-based paints. The properties of TiO₂-based paints may be able to keep coated roofs and walls cooler than uncoated ones, but do not yield cooling under strong sunlight. Many embodiments provide that raising Rₛₒₗₐᵣ can turn emissive coatings into more efficient radiative coolers. In several embodiments, coatings with higher Rₛₒₗₐᵣ continuously lose heat to the sky regardless of the time of day, and therefore reduce cooling loads of coated surfaces.

### Enhance Solar Reflectance With Pigment Materials

Many embodiments enhance Rₛₒₗₐᵣ of UV-reflective paints by material alterations. Since paints are optically inhomogeneous scattering media, some embodiments remove sources of solar absorption to enhance Rₛₒₗₐᵣ. Several embodiments replace conventional paint composition materials (such as rutile TiO₂) with UV-nonabsorptive pigments.

In many embodiments, rutile TiO₂ nanoparticles are replaced with UV-nonabsorptive pigments. Some embodiments use pigments with wide optical bandgaps. Several embodiments include semiconductor particles with bandgaps of at least 3.5 eV. Examples of the semiconductor particles include (but are not limited to): aluminum oxide, Al₂O₃ (bandgap at about 7.0 eV, corresponding wavelength λ at about 177 nm), barium sulfate, BaSO₄ (bandgap at about 6.0 eV, corresponding wavelength λ at about 208 nm), aluminum nitride (bandgap at about 6.0 eV, corresponding wavelength λ at about 208 nm), and calcium sulfate, CaSO₄ (bandgap at about 6.0 eV, corresponding wavelength λ at about 208 nm).

Certain embodiments include pigments with indirect bandgaps. In some embodiments, pigment materials include semiconductor particles with indirect bandgap of at least 3.1 eV. Examples of semiconductor particles with indirect bandgaps include (but are not limited to): anatase TiO₂. Anatase TiO₂ with an indirect bandgap at about 3.2 eV (corresponding wavelength λ at about 385 nm) can lower blue and ultraviolet absorption compare to rutile TiO₂ in accordance with some embodiments. In several embodiments, the relatively high refractive index of anatase TiO₂ can enable a high scattering efficiency when embedded in a polymeric matrix (refractive index at about 1.5). The refractive index (n) of anatase TiO₂ is greater than 2 across most of the solar wavelengths.

Some embodiments implement UV-reflective paints pigments with polymeric materials. A number of embodiments include fluoropolymer powder pigments. Examples of the fluoropolymer powders include (but are not limited to): ethylenetetrafluoroethylene (ETFE), fluorinated ethylene propylene (FEP), fluoroethylene vinyl ether (FEVE), polyvinylidene-fluoride, poly(vinylidene fluoride-co-hexafluoropropene), and polytetrafluoroethene (PTFE) particles, which have minimal absorptance in the solar wavelengths.

Many embodiments implement a mixture of at least two UV-reflective pigments to enhance reflection in the solar wavelengths. Several embodiments enhance the solar reflectance by enhancing the refractive index contrast of the UV-reflective pigment mixture. In some embodiments, the refractive index contrast of the pigment mixture (Δn) equals to the difference of the refractive index of the at least two pigment materials (n₁-n₂). Several embodiments provide that the absolute vale of the refractive index contrast (Δn) is at least 0.1. One major limitation of many UV-reflective pigments in accordance with many embodiments is their low refractive index. For example, BaSO₄ has refractive index (n) of about 1.6, CaSO₄ with n of about 1.5 and Al₂O₃ with n of about 1.7. When embedded in polymers with similar refractive indices (such as n of about 1.5), this reduces the scattering efficiency of the pigments and lead to lower reflectance, thus requiring a higher paint coating thickness and leading to overuse. Consequently, pigment materials with low refractive indices are primarily used in paints as fillers between reflective rutile TiO₂ pigments, rather than as reflective pigments themselves. In many embodiments, lowering the refractive index of the medium surrounding the particles including (but not limited to) increasing the refractive index contrast, can increase scattering efficiencies of the pigments, allowing them to be used as reflective white pigments.

In many embodiments, pigments with low and high refractive indexes in the solar wavelengths can be chosen to maximize refractive index contrast across constituents of the paint coatings, enhancing the scattering of UV and other solar wavelengths by the pigments, and hence reflectance. Some embodiments include materials with high refractive index of at least 1.5. Certain embodiments include materials with high refractive index of greater than 2. A number of embodiments include materials with low refractive index of less than 1.45. In several embodiments, refractive index contrast (Δn) of the mixture pigment material is greater than 0.1. In some embodiments, pigment material mixture can include at least one high refractive index material including (but not limited to): BaSO₄, Al₂O₃, CaSO₄, AlN and anatase TiO₂. In several embodiments, pigment material mixture can include at least one low refractive index material including (but not limited to): PTFE (n of about 1.35), FEP (n of about 1.34), ETFE (n of about 1.40), magnesium fluoride (MgF₂, n of about 1.38), P(VdF-HFP) (n of about 1.40), and PVdF (n of about 1.42) and FEVE (n of about 1.43). Some embodiments provide that MgF₂ and/or PTFE can be used as pigment materials in the coating. A number of embodiments provide that powder form of ETFE, FEVE, PVdF and P(VdF-HFP) can be used as pigment materials. Certain embodiments include that ETFE, FEVE, PVdF and P(VdF-HFP) can be used as binder materials.

Some embodiments implement a mixture of at least one UV-reflective pigment and at least one void (n of about 1) to maximize refractive index contrast and enhance reflection in the solar wavelengths. In certain embodiments, a void can be a pore that remains unfilled with polymer in a composite material. Several embodiments employ a mixture with a high pigment to polymer binder volume ratio. Beyond a certain volume ratio threshold, known as the critical particle volume concentration, the polymer binder insufficiently penetrates the space between pigments and enables pores containing air to form, which may enhance refractive index contrast and thus reflectance in accordance with many embodiments.

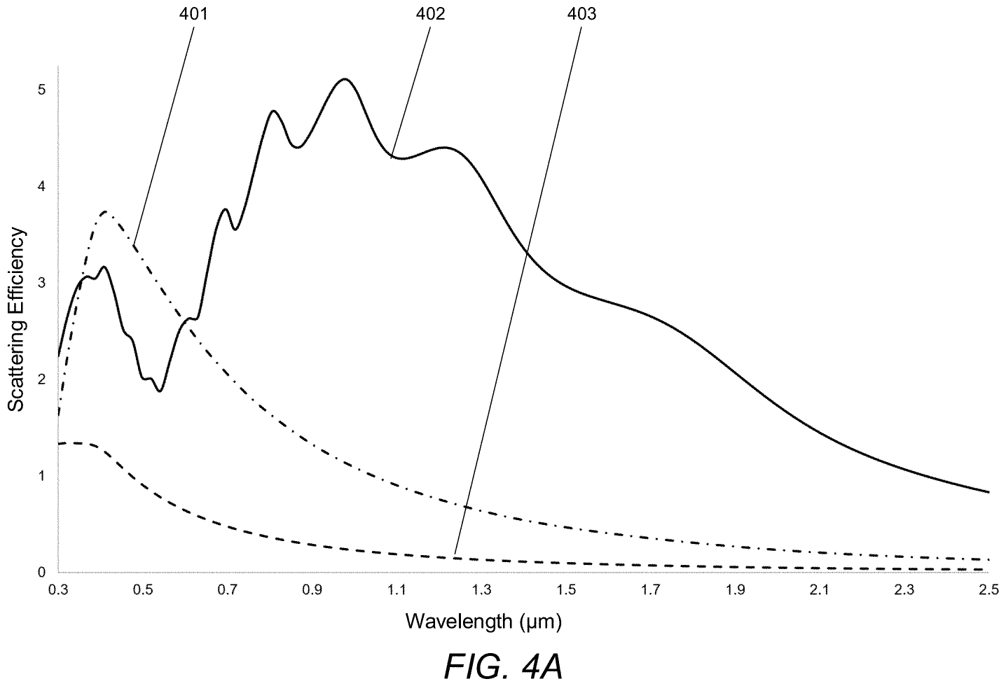

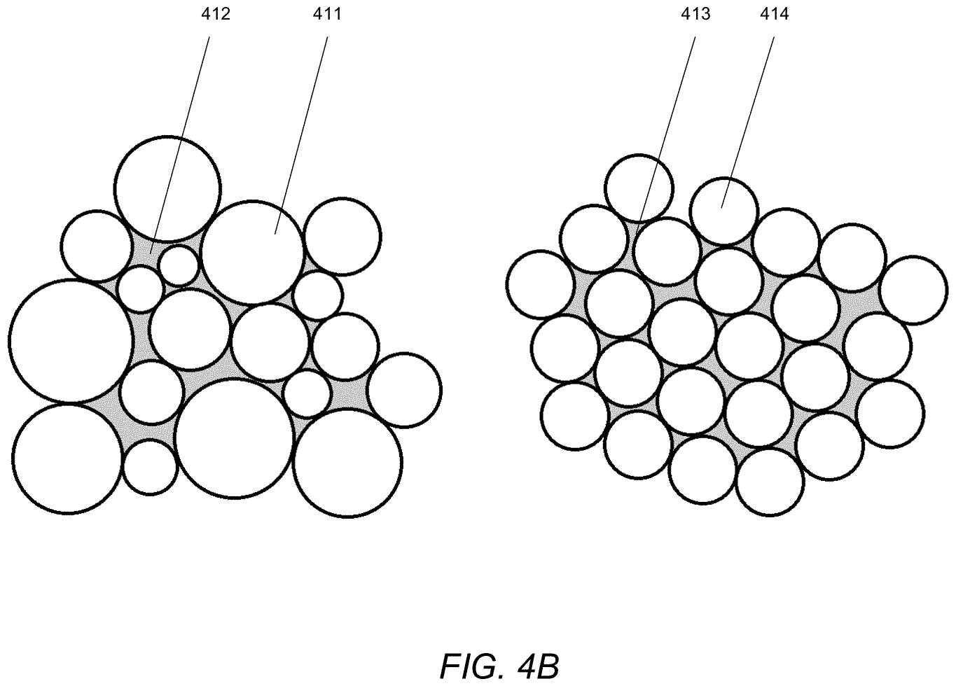

A schematic of scattering efficiency of pigment materials as a function of refractive index of environment in accordance with an embodiment of the invention is illustrated in FIG. 4A. In FIG. 4A, a high refractive index material BaSO₄ pigment material (n of about 1.6) is embedded in acrylic paint resin (n of about 1.5), in a low refractive index material (n of about 1.38), and in air (n of about 1) respectively. BaSO₄ pigment material particles have a diameter of about 1 μm. BaSO₄ embedded in acrylic paint resin (403) shows poor scattering and reflection of light. BaSO₄ embedded in the low index material (401) shows moderate scattering and reflection of light. BaSO₄ embedded in air (402) shows optimal scattering and reflection of light. Many embodiments provide that the mixture of low and high refractive index materials and/or voids enhance scattering efficiency and reflection of light. FIG. 4A shows scattering efficiency of the high refractive index material BaSO₄, similar behavior would be for pigment materials of similar high refractive index including (but not limited to): Al₂O₃, CaSO₄. Some embodiments provide that high refractive index materials AlN and TiO₂ exhibit high scattering efficiency and reflection of light when mixed with acrylic. Several embodiments further improve scattering efficiency and reflection of light of AlN and TiO₂ based coatings by mixing with low refractive index materials (n is less than 1.45).

The scattering efficiency of the high and low-index pigments, and any air voids around them, can be increased by optimizing their size, and is a conventional practice by the paints industry. However, given that in a mixture of scatterers like pigments and/or voids, types of scatterers complement each other in terms of volume, optimizing the size distribution of any one type of pigment may lead to sub-optimal scattering by other pigments which fit in between the pigments. To ensure the broadband scattering and reflectance of sunlight, many embodiments implement a wide size distribution of pigment particle diameter from about 100 nm to about 3 μm. In some embodiments, the particle and/or powder diameters have a distribution with a standard deviation of greater than 1 μm for broadband solar scattering. In a number of embodiments, the coating has a pigment to binder volume ratio exceeding the critical pigment volume concentration to achieve at least one air void. The diameters of the air voids have a wide size distribution with a standard deviation of greater than 1 μm for broadband solar scattering. Several embodiments select a desirable size distribution for each type of scatterer. This can lead to high scattering efficiencies by the ensemble of that type of scatterer across the solar wavelengths in accordance with certain embodiments. In several embodiments, it can also lead to a wide size distribution for the gaps between the scatterers, which can accommodate widely varying sizes of scatters of other types. Many embodiments achieve a high broadband scattering by various types of scatterers including (but not limited to): different types of pigments and voids, and a high solar reflectance.

A schematic of scattering efficiency of pigment particles as a function of particle size distribution in accordance with an embodiment of the invention is illustrated in FIG. 4B. Pigment particles with a wide particle diameter distribution (411) can achieve a wide size distribution of spaces (412) between individual particles. The wider size distribution of spaces (412) can accommodate a wide variety of sizes of other optical scatterers including (but not limited to): pigments and voids. In comparison, pigment particles with a narrow diameter distribution (414) have a narrow size distribution of spaces (413) between individual particles. The narrower size distribution of spaces (413) may impose a greater restriction on sizes of optical scatterers including (but not limited to): pigments and voids.

### Enhance Solar Reflectance With Binder Materials

Many embodiments enhance the Rₛₒₗₐᵣ of UV-reflective coatings by using low-refractive index polymer binders with low UV and NIR absorptivity. Some embodiments include binders for non-aqueous paints. Examples of non-aqueous paints include (but are not limited to): poly(vinylidene fluoride), (P(VdF)), poly(vinylidene fluoride-co-hexafluoropropylene), (P(VdF-HFP)), and solvent-based silicone dispersions.

Several embodiments include binder materials for aqueous paints including (but not limited to) paintable coatings. Many embodiments provide that aqueous systems have properties including (but not limited to): low volatile-organic-compound (VOC) content and eco-friendliness. In some embodiments, aqueous paints might be better suited for on-site application on roofs. Several embodiments provide that aqueous systems may be able to be stored and transported in dry forms, and be turned into liquid form by the addition of water on site of application. Examples of aqueous paints include (but are not limited to) water-based dispersions of fluoropolymers such as fluoroethylene vinyl ether (FEVE), water-based silicone dispersions, and fluoropolymer-acrylic latexes.

Many embodiments implement fluoropolymer as binder materials. In certain embodiments, fluoropolymers with low absorption in the solar and/or the solar-infrared wavelengths can be chosen. Several embodiments avoid acrylic and/or silicone as binder polymers. Compared to acrylic or silicone, fluoropolymer variants have fewer C—H or O—H bonds, which absorb sunlight at wavelengths (λ) of about 1.2 μm, about 1.4 μm, about 1.7 μm, and about 2.3 μm. In addition, fluoropolymer variants have more C—F bonds, which weakly absorb sunlight at wavelengths (λ) of about 2.1 μm. Moreover, fluoropolymers absorb less UV than acrylics, further enhancing Rₛₒₗₐᵣ. The presence of ultraviolet chromophores in acrylic can lead to yellowing under long-term exposure to sunlight, which further increases solar absorption and reduces radiative cooling performance in accordance with some embodiments. In several embodiments, fluoropolymers and/or fluoropolymer based variants are resistant to turning yellow under long-term exposure to sunlight.

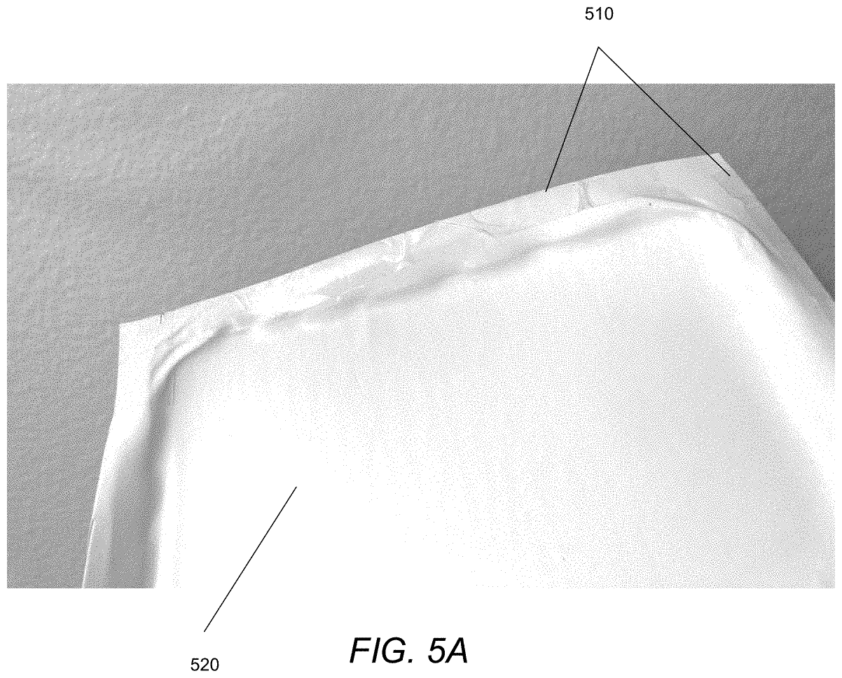

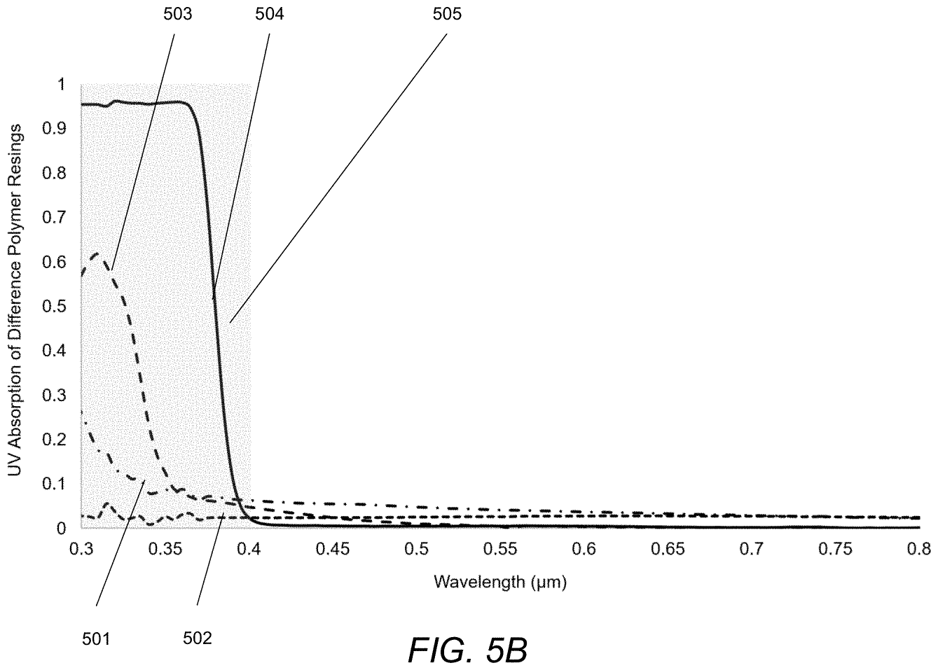

A picture of acrylic adhesive film and fluoropolymer-based coating under UV exposure in accordance with an embodiment of the invention is illustrated in FIG. 5A. The acrylic film and the fluoropolymer coating have been exposed under various weather conditions including (but not limited to) UV exposure. The fluoropolymer-based coating (520) does not show any color alteration after being exposed under UV light. In comparison, the acrylic adhesive film around fluoropolymer (510) turns yellow after UV exposure. A number of embodiments provide that the presence of ultraviolet chromophores in acrylic can lead to yellowing under long-term exposure to sunlight. In comparison, fluoropolymers and/or fluoropolymer based variants are resistant to turning yellow under long-term exposure to sunlight in accordance with several embodiments.

Many embodiments provide that pigment materials mixed with fluoropolymer and/or fluoropolymer variants have a higher solar scattering efficiency than mixing with acrylic. Because fluoropolymer binders and/or their variants have lower refractive indices (n) that range from about 1.38 to about 1.43, compared to the refractive index of acrylic of about 1.495, pigment materials including (but not limited to): BaSO₄, CaSO₄, Al₂O₃, aluminum nitride, and anatase TiO₂ embedded in fluoropolymers and/or their variants have a higher solar scattering efficiency than those in acrylic in accordance with several embodiments. Examples of low refractive index fluoropolymer and/or their variants are listed in Table 1. Some embodiments provide that due to the higher contrast in refractive index, an identical distribution of pigments embedded in a fluoropolymer and/or fluoropolymer variants matrix has a higher Rₛₒₗₐᵣ than in acrylic. Many embodiments include that silicone has a lower refractive index than acrylic. In several embodiments, mixing pigment materials with silicone can enhance reflectance of the paint.

A schematic of UV absorption of different polymer resin films in accordance with an embodiment of the invention is illustrated in FIG. 5B. In FIG. 5B, UV absorption of fluoropolymer FEVE and PVdF, silicone, and acrylic are shown. Acrylic resin film (504) shows a higher than 0.9 UV absorption in solar UV wavelengths (505). FEVE resin film (503) shows a much lower UV absorption than acrylic in solar UV wavelengths (505). Silicone film (501) shows a lower UV absorption than FEVE film in solar UV wavelengths (505). PVdF film shows the lowest (almost close to 0) UV absorption in solar UV wavelengths (505). Fluoropolymers and silicone have lower UV absorptances than acrylic in accordance with several embodiments. Some embodiments avoid acrylic in the coating to lower UV absorption.

In many embodiments, solar absorptance can be lowered by reducing the amount of polymer in the paint. Reducing the amount of polymer relative to the pigment below a certain threshold, known as critical particle volume concentration, can lead to the formation of voids in the paint film in accordance with some embodiments. The presence of voids can increase the refractive index contrast between the pigments and the surrounding environment, further enhancing solar reflectance.

In several embodiments, the binder polymers can impart a high thermal emittance to the coating. Fluoropolymers including (but not limited to) P(VdF), P(VdF-HFP), FEVE and their variants have a high broadband emittance (wavelengths from about 6 to about 25 μm). In some embodiments, high broadband emitters of fluoropolymers and their variants can subtend the LWIR atmospheric transparency window due to the intrinsic absorption of C—H and C—C bonds in the 8 μm to 13 μm wavelength range and C—F bonds in the 16 μm to 25 μm wavelength range. In certain embodiments, the pigment materials (which may be thermally emissive themselves) and the pores embedded in the emissive polymer can scatter and increase the optical path length of thermal radiation, further enhancing the broadband emittance. Many embodiments provide that broadband emittance can be better suited for radiative cooling designs including (but not limited to) building envelopes exposed to the elements.

### Passive Daytime Radiative Cooling Coating

Several embodiments provide that the enhancement of solar reflectance with pigment and/or binder materials are compatible with paint design. In many embodiments, the coating may contain at least one pigment material and at least one of binder materials. The combination of the pigment and binder material may include additives in accordance with some embodiments. Depending on the materials selected from the pigment and binder, some embodiments implement water or organic solvent for dispersing the chosen materials, and/or dissolving the polymer binder. Certain embodiments implement coalescing agents including (but not limited to) triethyl phosphate, polyethylene glycol and 2-Butoxyethanol. A number of embodiments include thickening agents including (but not limited to) methylcellulose.

In many embodiments, alterations with high solar reflectance pigment materials and polymer binder materials are compatible with TiO₂-based white paint, a super-white PTFE-based reflectance standard (such as, Spectralon® SRM-99), porous P(VdF-HFP) and silvered emitters. Some embodiments provide that in the absence of intrinsic UV-absorption, scattering by pigments can result in high UV-blue reflectance. In several embodiments, reducing polymer content may yield similar results in the NIR wavelengths. In certain embodiments, Rₛₒₗₐᵣ can reach about 0.98 for the BaSO₄ paint coatings. In a number of embodiments, Rₛₒₗₐᵣ may exceed 0.94 for the Al₂O₃ and the PTFE-based paint coatings.

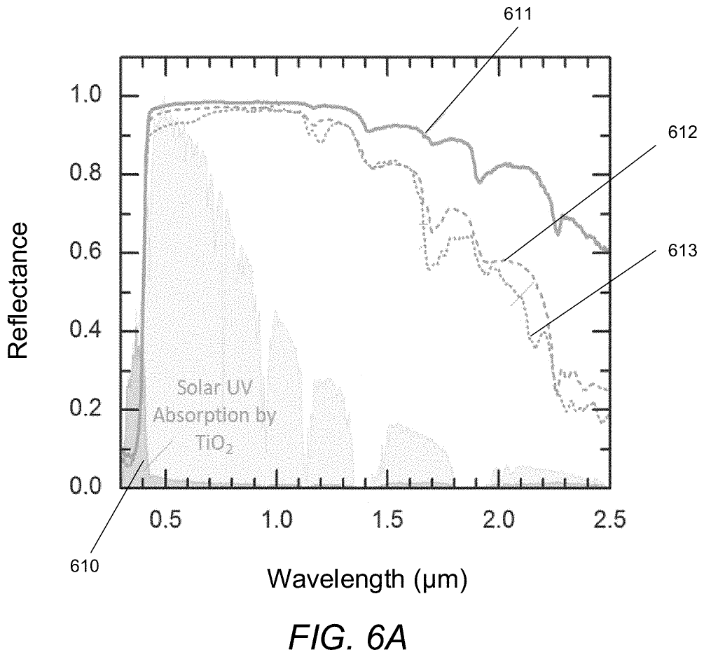

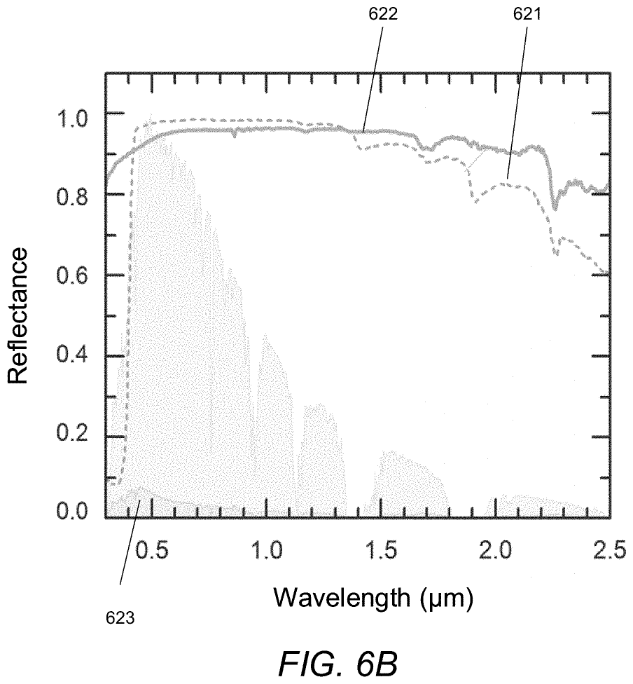

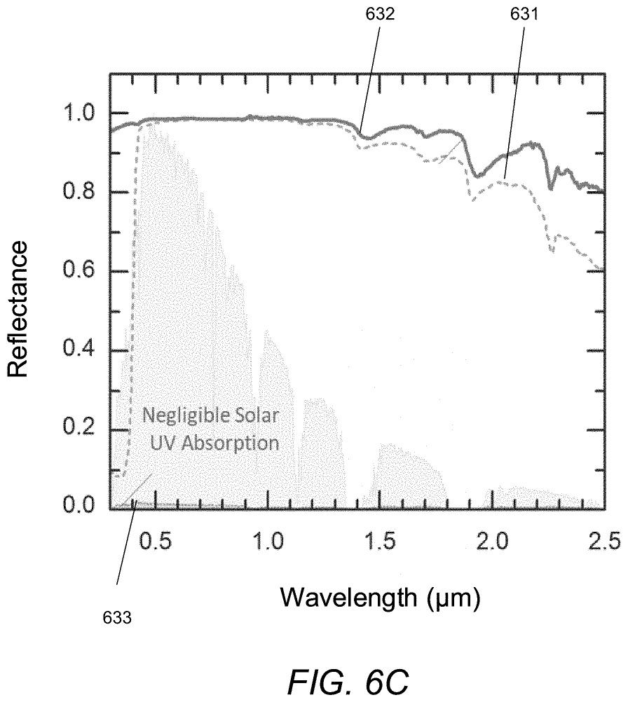

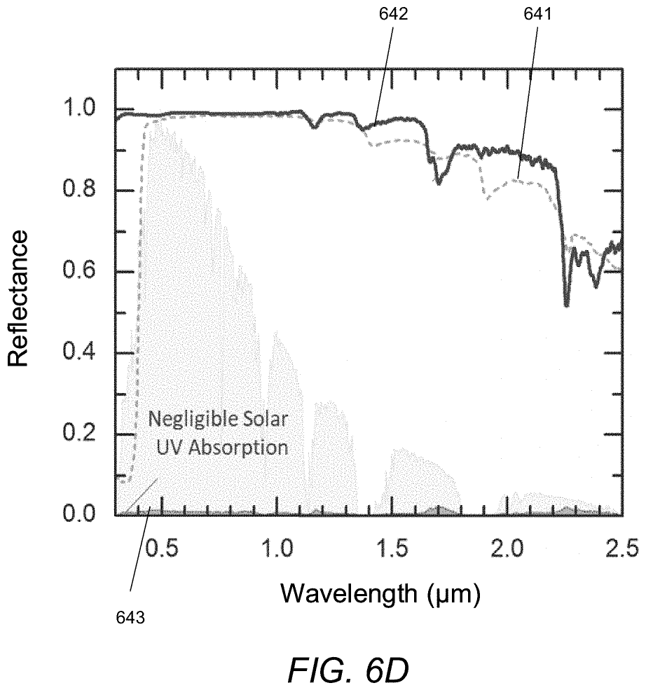

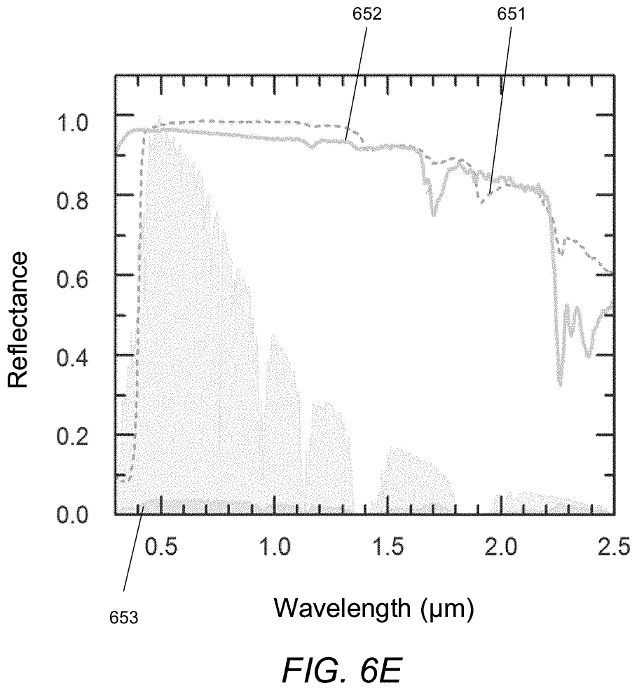

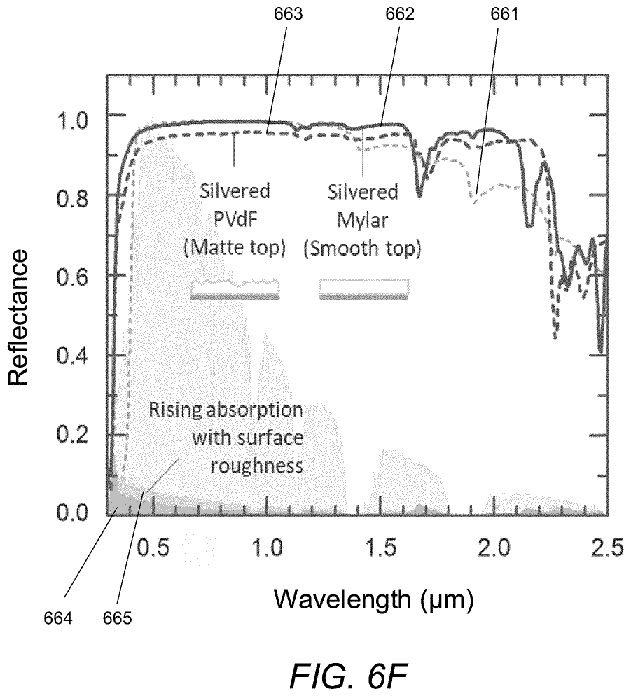

Spectral reflectance in solar wavelength of TiO₂ based paint materials in accordance with an embodiment of the invention is illustrated in FIG. 6A. The thickness of paint films is about 1 mm. Solar UV absorption by rutile TiO₂ (610) is shown in the UV wavelength range. Solar reflectance of 93 wt % of rutile TiO₂ in P(VdF-HFP) (611) shows a relatively higher solar reflectance when compared to both 50 wt % of rutile TiO₂ in P(VdF-HFP) (612) and 50 wt % of rutile TiO₂ in acrylic (613). TiO₂ particles can scatter light, hence improving reflectance of 93 wt % of rutile TiO₂ in P(VdF-HFP) (611) than 50 wt % of rutile TiO₂ in P(VdF-HFP) (612). P(VdF-HFP) is a fluoropolymer and absorbs less sunlight than acrylic, hence improving solar reflectance. 50 wt % of rutile TiO₂ in P(VdF-HFP) (612) shows higher reflectance than 50 wt % of rutile TiO₂ in acrylic (613) as well, resulting from absorption of polymer binder. Decrease the amount of TiO₂ in coatings can decrease sunlight absorption and improve solar reflectance of emissive coatings. Implementation of higher solar reflectance polymer binder materials in emissive coatings enhance overall solar reflectance of the coatings in accordance with some embodiments.

Spectral reflectance in solar wavelength of Al₂O₃ based paint materials in accordance with an embodiment of the invention is illustrated in FIG. 6B. The thickness of paint films is about 1 mm. Solar UV absorption by Al₂O₃ (623) is shown in the UV wavelength range. The solar UV absorption of Al₂O₃ based paint (623) is lower than the solar UV absorption of rutile TiO₂ based paint (610), as the pigment material Al₂O₃ absorbs less UV light than TiO₂ Hence, 93 wt % of rutile TiO₂ in P(VdF-HFP) (621) shows lower solar reflectance than 96 wt % of Al₂O₃ in P(VdF-HFP) (622) in the NIR wavelengths. Implementation of higher solar reflectance pigment materials in emissive coatings enhance overall solar reflectance of the coatings in accordance with some embodiments.

Spectral reflectance in solar wavelength of BaSO₄ based paint materials in accordance with an embodiment of the invention is illustrated in FIG. 6C. The thickness of paint films is about 1 mm. Solar UV absorption by BaSO₄ (633) is shown in the UV wavelength range. The solar UV absorption of BaSO₄ based paint (633) is almost negligible, much lower than the solar UV absorption of rutile TiO₂ based paint (610), as the pigment material BaSO₄ absorbs less UV light than TiO₂ Hence, 93 wt % of rutile TiO₂ in P(VdF-HFP) (631) shows lower solar reflectance than 94 wt % of BaSO₄ in P(VdF-HFP) (632) in the NIR wavelengths. Implementation of higher solar reflectance pigment materials in emissive coatings enhance overall solar reflectance of the coatings in accordance with some embodiments.

Spectral reflectance in solar wavelength of porous P(VdF-HFP) based paint materials in accordance with an embodiment of the invention is illustrated in FIG. 6D. The thickness of paint films is about 1 mm. Solar UV absorption by porous P(VdF-HFP) (643) is shown in the UV wavelength range. The solar UV absorption of porous P(VdF-HFP) based paint (643) is almost negligible, as the binder material porous P(VdF-HFP) absorbs less UV light. Hence, 93 wt % of rutile TiO₂ in P(VdF-HFP) (641) shows lower solar reflectance than porous P(VdF-HFP) (642) in the NIR wavelengths. Implementation of higher solar reflectance binder polymer materials in emissive coatings enhance overall solar reflectance of the coatings in accordance with some embodiments.

Spectral reflectance in solar wavelength of PTFE based paint materials in accordance with an embodiment of the invention is illustrated in FIG. 6E. The thickness of paint films is about 1 mm. Solar UV absorption by PTFE (653) is shown in the UV wavelength range. The solar UV absorption of PTFE based paint (653) is almost negligible, much lower than the solar UV absorption of TiO₂ based paint (610), as the pigment material PTFE absorbs less UV light than TiO₂ However, 93 wt % of rutile TiO₂ in P(VdF-HFP) (651) shows similar solar reflectance with 80 wt % of PTFE in P(VdF-HFP) (652) in the NIR wavelengths.

Spectral reflectance in solar wavelength of silvered polymers based paint materials in accordance with an embodiment of the invention is illustrated in FIG. 6F. The thickness of paint films is about 1 mm. Solar UV absorption by silvered PVdF with a matte top (665) and solar UV absorption by silvered mylar with smooth top (664) are shown in the UV wavelength range. The solar UV absorption of silvered PVdF with a matte top (665) is lower than the solar UV absorption of silvered mylar with smooth top (664), showing rising absorption of UV light with surface roughness. 93 wt % of rutile TiO₂ in P(VdF-HFP) (661) shows lower solar reflectance than both silvered PVdF with a matte top (663) and silvered mylar with smooth top (662) in the NIR wavelengths.

Many embodiments provide radiative coatings with enhanced pigment materials and/or polymer binder materials exhibiting high solar reflectance. In some embodiments, the BaSO₄ and porous P(VdF-HFP) paint coatings have solar reflectance of about 0.98. In several embodiments, the Al₂O₃ and the PTFE-based paint coatings have solar reflectance of at least 0.94. Coatings with high solar reflectance combined with the high, broadband emitters can make radiative coatings near-ideal radiative coolers for buildings in accordance with certain embodiments.

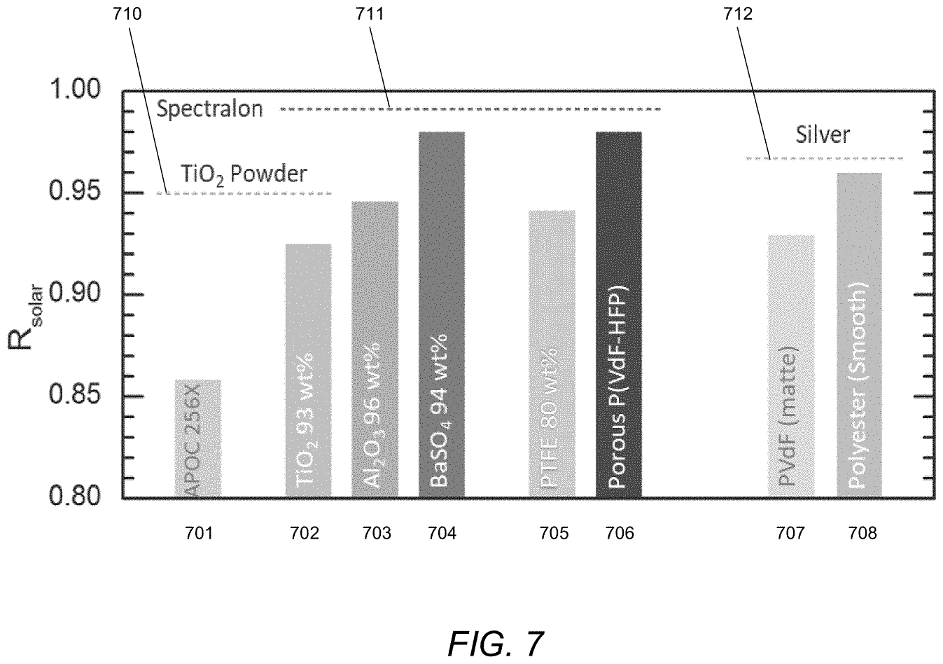

Comparison of solar reflectance (Rₛₒₗₐᵣ) of various paints and silvered plastics in accordance with an embodiment of the invention is illustrated in FIG. 7. In FIG. 7, solar reflectance of TiO₂ based paints (701, 702), wide bandgap pigment material paints (703, 704), polymeric paints (705, 706), and silvered plastics (707, 708) are listed and compared.

APOC 256X paint (701) is a TiO₂ based paint, and is one of the most reflective paint (rated by the Cool Roof Rating Council). APOC 256X paint (701) has a Rₛₒₗₐᵣ of about 0.86. 93 wt % TiO₂ based paint (702) is a TiO₂ based paint, and has a Rₛₒₗₐᵣ of about 0.93. In comparison, TiO₂ powder (710) has a Rₛₒₗₐᵣ of about 0.95, and represent the likely upper limits of Rₛₒₗₐᵣ of TiO₂-based radiative coolers.

96 wt % Al₂O₃ based paint (703) is a wide bandgap pigment material based paint, and has a Rₛₒₗₐᵣ of greater than 0.94 and less than 0.95. BaSO₄ based paint (704) is a wide bandgap pigment material based paint, and has a Rₛₒₗₐᵣ of about 0.98. In comparison, rutile TiO₂ powder (710) has a Rₛₒₗₐᵣ of about 0.95. Spectralon (711) is a fluoropolymer and comprises porous PTFE. Spectralon (711) is one of the whitest material and has a solar reflectance of about 0.99. The Rₛₒₗₐᵣ of Spectralon represents the likely upper limits of Rₛₒₗₐᵣ of polymer-based radiative coolers.

80 wt % PTFE (704) is a polymeric paint and has a Rₛₒₗₐᵣ of about 0.94. Porous P(VdF-HFP) (705) is a polymeric paint and has a Rₛₒₗₐᵣ of about 0.98. In comparison, Spectralon (711) has a Rₛₒₗₐᵣ of about 0.99.

PVdF with a matte surface (707) is a silvered plastic, and has a Rₛₒₗₐᵣ of about 0.93. Polyester with a smooth surface (708) is a silvered plastic, and has a Rₛₒₗₐᵣ of about 0.96. In comparison, silver (712) has a Rₛₒₗₐᵣ of about 0.97, and represents the likely upper limits of Rₛₒₗₐᵣ of silvered radiative coolers

Many embodiments provide that broadband emitters with high emissivity can be combined with high solar reflectance materials in radiative coatings. Several embodiments provide that incorporating broadband emitters broaden the choice of emitter materials for radiative coolers in PDRC. In some embodiments, LWIR emitters with high emissivity can be incorporated into coatings for PDRC.

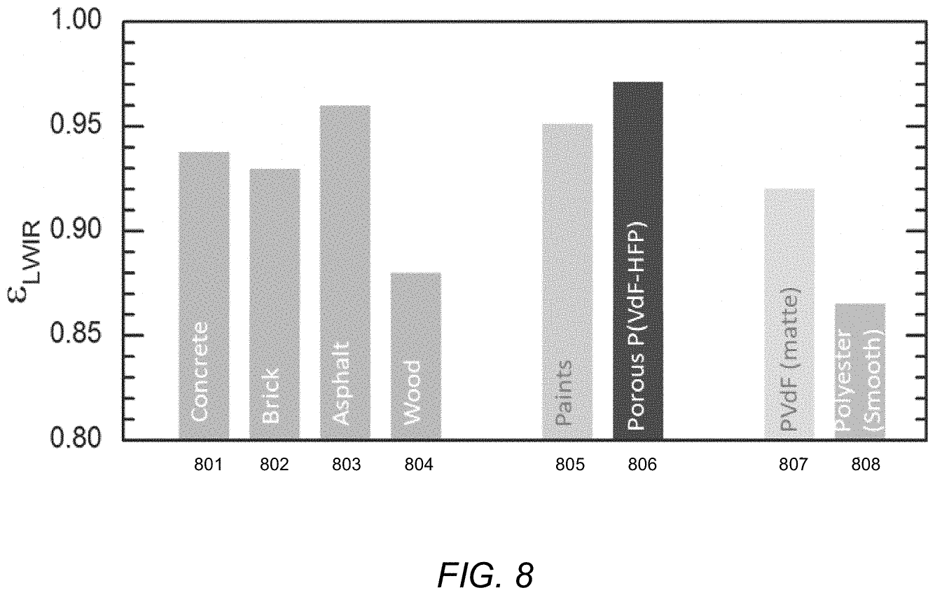

Comparison of LWIR emissivity (ϵ_{LWIR}) of building materials, paints and silvered emitters in accordance with an embodiment of the invention is illustrated in FIG. 8. In FIG. 8, LWIR emissivity of building surface materials (801-804), paints (805, 806), and silvered plastics (807, 808) are listed and compared.

Building surface materials include concrete (801), brick (802), asphalt (803), and wood (804). Concrete (801) has a ϵ_{LWIR} of about 0.94, brick (802) with a ϵ_{LWIR} of about 0.93, asphalt (803) with a ϵ_{LWIR} of about 0.96, and wood (804) with a ϵ_{LWIR} of about 0.88.

TiO₂ based paint (805) has a ϵ_{LWIR} of about 0.95. Porous P(VdF-HFP) (806) based paint has a ϵ_{LWIR} of about 0.97.

PVdF with a matte surface (807) is a silvered plastic with a ϵ_{LWIR} of about 0.92. Polyester with a smooth surface (808) is a silvered plastic with a ϵ_{LWIR} of about 0.87.

Radiative cooling coatings in accordance with many embodiments can be applied by a painting technique, a spraying technique, and/or dip-coating. Upon drying, the coatings, in sufficient thicknesses, can achieve solar reflectance ranges from about 0.94 to about 0.98 in several embodiments. Some embodiments enable significant power savings in buildings by enhanced passive cooling.

Many embodiments provide that the UV-reflective coatings can be applied as a top-coat on a rutile TiO₂-based white paint. Typical scattering media such as paints see shallower penetration into the coating by shorter wavelengths including UV and/or blue light, and deeper penetration by longer wavelengths. Thus, when placed as a thin top-coat, the UV-reflective coatings can reflect the UV light before the light reaches the rutile TiO₂-based paint underneath in accordance with several embodiments. In some embodiments, the longer solar wavelengths can be partially reflected by the top-coat. The rest of the wavelengths can penetrate into the paint underneath, where they are scattered and reflected back in accordance with some embodiments. In some embodiments, the pigment particle diameter of the UV-reflective top-coat can be optimized to about 200 nm to maximize reflectance of UV light and blue light. Many embodiments provide that the reduced UV-absorption can increase the solar reflectance of the multilayer coating by at least 4% compared to the bare rutile TiO₂-based paint, while retaining the rutile TiO₂-based paint's scattering efficiency at longer wavelengths. Several embodiments enable a smaller total thickness of the double-layer film to achieve a high solar reflectance.

In many embodiments, the UV-reflective paints can be applied in the form of a dry coating. In several embodiments, a dry mixture of at least one pigment material and at least one binder material with a low refractive index of less than 1.45. Some embodiments provide that the pigment materials can have a high refractive index of greater than 1.5. Certain embodiments provide that the pigment materials can have a low refractive index of less than 1.45. In several embodiments, the high refractive index binder material and the low refractive index pigment material have an absolute value of the difference between the refractive indices greater than 0.1. In some embodiments, the high refractive index pigment material and the low refractive index pigment material have an absolute value of the difference between the refractive indices greater than 0.1. Examples of pigment powder materials in dry coatings include (but are not limited to): BaSO₄, Al₂O₃, PTFE, MgF₂, PTFE, FEP, and ETFE. Examples of binder powder materials include (but are not limited to): PVdF and its variants, FEVE and its variants, and poly(vinylidene fluoride-co-hexafluoropropene) (P(VdF-HFP)) and its variants. In certain embodiments, the dry coating has a pigment to binder volume ratio exceeding the critical pigment volume concentration to achieve air voids for broadband solar scattering. The air voids have a wide diameter distribution with a standard deviation of greater than 1 μm. The dry coatings can be coated on a substrate using a tool including (but not limited to): a spray, an applicator. In some embodiments, the substrate can then be baked at a high temperature (between about 60° C. and about 200° C.) to melt the polymer binder and then cooled, which can yield a cohesive paint film. The cohesive paint film in accordance with some embodiments can be a pigment-binder matrix that adheres to the substrate. Many embodiments provide that this process can be suitable to factory-based coating applications, which can be done on sheet metals. By carefully adjusting the ratio of binder powder and pigment, it is possible to incorporate voids into the coating in order to maximize refractive index contrast and thus solar reflectance in accordance with several embodiments.

In many embodiments, the high PDRC capability achievable by white paints can be complemented by their convenience of use. These paints are inexpensive and easy to apply on surfaces. The paint coatings have also been chemically engineered to impart high durability in accordance with some embodiments. Certain embodiments implement paints based on silicone. Several embodiments implement fluoropolymer and cross-linkable binders that are resistant to UV-damage and weathering, and remain stable under the sky for years. With these attributes considered in addition to the optical properties, UV-reflective paints can be an effective platform for large scale radiative cooling of buildings.

Many embodiments provide maximizing Rₛₒₗₐᵣ and ϵ_{LWIR} with minimal use of material. In some embodiments, a high ϵ_{LWIR} could be achieved by intrinsically emissive pigments with specific microscale sizes. Several embodiments apply coating paints on emissive substrates.

Many embodiments provide reducing the glare of the UV-reflective paint. While reflection off white paints is diffuse and less intense than those off silvered designs, it may harm eyesight and heat dark structures in view. Coating super-white paints with commercial retroreflective spheres may reduce the glare in accordance with several embodiments.

Some embodiments provide the durability of the paints. Several embodiments improve durability of paints including (but not limited to) fluoropolymer-based paints to lower year-averaged costs.

Several embodiments provide that color can be an aesthetic choice and solution to glare. Selectively visible-absorbing colorants can be added to the paints to maximize solar reflectance and cooling performance while achieving color in accordance with certain embodiments.

### Doctrine of Equivalents

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What is claimed is:

1. A passive daytime radiative cooling coating comprising:
at least one pigment material with a refractive index of greater than 1.5;
at least one binder material with a refractive index of less than 1.45; and
at least one solvent, wherein the at least one binder material is soluble in the solvent;
wherein an absolute value of the difference between the refractive indices of the pigment material and the binder material is at least 0.1; and
wherein the coating has a solar reflectance of at least 0.94.

2. The coating of claim 1, wherein the pigment material comprises a semiconductor particle with a bandgap of at least 3.5 eV.

3. The coating of claim 2, wherein the semiconductor particle is aluminum oxide, aluminum nitride, barium sulfate, calcium sulfate, or silicon oxide.

4. The coating of claim 1, wherein the pigment material comprises a semiconductor particle with an indirect bandgap of at least 3.1 eV.

5. The coating of claim 4, wherein the semiconductor particle is anatase titanium oxide.

6. The coating of claim 1, wherein the pigment material is in a powder form and the powder has a diameter from about 100 nm to about 3 μm.

7. The coating of claim 6, wherein the powder diameters have a distribution with a standard deviation of greater than 1 μm for broadband solar scattering.

8. The coating of claim 1, wherein the binder material comprises a fluoropolymer and the fluoropolymer is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), or poly(vinylidene fluoride) (PVdF).

9. The coating of claim 1, wherein the binder material is magnesium fluoride (MgF₂).

10. The coating of claim 8, wherein the fluoropolymer has an emittance of at least 0.8 in wavelength range from about 6 μm to about 25 μm.

11. The coating of claim 1, wherein the coating has a pigment to binder volume ratio exceeding the critical pigment volume concentration to achieve at least one air void, wherein the at least one air void has a refractive index of about 1.

12. The coating of claim 11, wherein the at least one air void has a diameter and the diameters have a distribution with a standard deviation of greater than 1 μm for broadband solar scattering.

13. The coating of claim 1 further comprising a second pigment material with a refractive index of less than 1.45.

14. The coating of claim 13, wherein the second pigment material is in a powder form and the second pigment material is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), poly(vinylidene fluoride) (PVdF), or magnesium fluoride (MgF₂).

15. The coating of claim 14, wherein the powder has a diameter from about 100 nm to about 3 μm.

16. The coating of claim 15, wherein the powder diameters have a distribution with a standard deviation of greater than 1 μm for broadband solar scattering.

17. The coating of claim 13, wherein an absolute value of the difference between the refractive indices of the two pigment materials is at least 0.1.

18. The coating of claim 13, wherein the binder material comprises a polymer and the polymer is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), poly(vinylidene fluoride) (PVdF), or silicone.

19. The coating of claim 13, wherein the coating has a pigment to binder volume ratio exceeding the critical pigment volume concentration to achieve at least one air void, wherein the at least one air void has a refractive index of about 1.

20. The coating of claim 19, wherein the at least one air void has a diameter and the diameters have a distribution with a standard deviation of greater than 1 μm for broadband solar scattering.

21. The coating of claim 1, wherein the binder material is water soluble and comprises at least one of fluoroethylene vinyl ether, silicone, or fluoropolymer-acrylic latexes.

22. The coating of claim 1, wherein the binder material is not water soluble and comprises poly(vinylidene fluoride) or poly(vinylidene fluoride-co-hexafluoropropene).

23. The coating of claim 1, further comprising at least one coalescing agent.

24. The coating of claim 23, wherein the coalescing agent is triethyl phosphate, polyethylene glycol, or 2-Butoxyethanol.

25. The coating of claim 1, further comprising at least one thickening agent.

26. The coating of claim 25, wherein the thickening agent is methylcellulose.

27. The coating of claim 1, wherein the coating is a paint or a spray.

28. The coating of claim 1, wherein the coating is applied as a UV-reflective top coat on an UV-absorptive rutile TiO₂-based white paint.

29. A passive daytime radiative cooling dry coating comprising:
at least one pigment material;
at least one binder material with a refractive index of less than 1.45; and
wherein the coating has a solar reflectance of at least 0.94; and
wherein the coating is applied as a dry coat on a substrate.

30. The dry coating of claim 29, wherein the pigment material is selected from the group consisting of aluminum oxide, barium sulfate, polytetrafluoroethene (PTFE), and magnesium fluoride (MgF₂).

31. The dry coating of claim 29, wherein the binder material is selected from the group consisting of poly(vinylidene fluoride) (PVdF), fluoroethylene vinyl ether (FEVE), and poly(vinylidene fluoride-co-hexafluoropropene) (P(VdF-HFP)).

32. The dry coating of claim 29, wherein the dry coating has a pigment to binder volume ratio exceeding the critical pigment volume concentration to achieve at least one air void, wherein the at least one air void has a refractive index of about 1.

33. The dry coating of claim 32, wherein the at least one air void has a diameter and the diameters have a distribution with a standard deviation of greater than 1 μm for broadband solar scattering.

34. The dry coating of claim 29, wherein the coating is applied on the substrate using a spray or an applicator.

35. The dry coating of claim 29, wherein the at least one pigment material has a refractive index of greater than 1.5 and an absolute value of the difference between the refractive indices of the pigment material and the binder material is at least 0.1.

36. The dry coating of claim 35, further comprising a second pigment material with a refractive index of less than 1.45.

37. The dry coating of claim 36, wherein the second pigment material is polytetrafluoroethene (PTFE), fluorinated ethylene propylene (FEP), ethylene tetrafluoroethylene (ETFE), or magnesium fluoride (MgF₂).

38. The dry coating of claim 36, wherein the dry coating has a pigment to binder volume ratio exceeding the critical pigment volume concentration to achieve at least one air void, wherein the at least one air void has a refractive index of about 1.

39. The dry coating of claim 38, wherein the at least one air void has a diameter and the diameters have a distribution with a standard deviation of greater than 1 μm for broadband solar scattering.

40. The dry coating of claim 29, wherein the coating is baked at a temperature between about 60° C. and about 200° C. to yield a cohesive film.

41. A method to cool an object comprising:
applying at least one layer of passive radiative cooling coating on at least one surface of the object, wherein the passive radiative cooling coating comprises:
at least one pigment material with a refractive index of greater than 1.5;
at least one binder material with a refractive index of less than 1.45; and
at least one solvent, wherein the at least one binder material is soluble in the solvent;
wherein an absolute value of the difference between the refractive indices of the pigment material and the binder material is at least 0.1; and
wherein the coating has a solar reflectance of at least 0.94.

42. The method of claim 41, wherein the object is an outdoor building.

43. The method of claim 41, wherein the pigment material comprises a semiconductor particle with a bandgap of at least 3.5 eV.

44. The method of claim 43, wherein the semiconductor particle is aluminum oxide, aluminum nitride, barium sulfate, calcium sulfate, or silicon oxide.

45. The method of claim 41, wherein the pigment material comprises a semiconductor particle with an indirect bandgap of at least 3.1 eV.

46. The method of claim 45, wherein the semiconductor particle is anatase titanium oxide.

47. The method of claim 41, wherein the pigment material is in a powder form and the powder has a diameter from about 100 nm to about 3 μm.

48. The method of claim 47, wherein the powder diameters have a distribution with a standard deviation of greater than 1 μm for broadband solar scattering.

49. The method of claim 41, wherein the binder material comprises a fluoropolymer and the fluoropolymer is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), or poly(vinylidene fluoride) (PVdF).

50. The method of claim 41, wherein the binder material is magnesium fluoride (MgF₂).

51. The method of claim 49, wherein the fluoropolymer has an emittance of at least 0.8 in wavelength range from about 6 μm to about 25 μm.

52. The method of claim 41, wherein the coating has a pigment to binder volume ratio exceeding the critical pigment volume concentration to achieve at least one air void, wherein the at least one air void has a refractive index of about 1.

53. The method of claim 52, wherein the at least one air void has a diameter and the diameters have a distribution with a standard deviation of greater than 1 μm for broadband solar scattering.

54. The method of claim 41, further comprising a second pigment material with a refractive index of less than 1.45.

55. The method of claim 54, wherein the second pigment material is in a powder form and the second pigment material is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), poly(vinylidene fluoride) (PVdF), or magnesium fluoride (MgF₂).

56. The method of claim 55, wherein the powder has a diameter from about 100 nm to about 3 μm.

57. The method of claim 56, wherein the powder diameters have a distribution with a standard deviation of greater than 1 μm for broadband solar scattering.

58. The method of claim 54, wherein an absolute value of the difference between the refractive indices of the two pigment materials is at least 0.1.

59. The method of claim 54, wherein the binder material comprises a polymer and the polymer is polytetrafluoroethene (PTFE), fluorinated ethylene propylene (FEP), ethylene tetrafluoroethylene (ETFE), fluoroethylene vinyl ether (FEVE), poly(vinylidene fluoride-co-hexafluoropropene) (P(VdF-HFP)), poly(vinylidene fluoride) (PVdF), or silicone.

60. The method of claim 54, wherein the coating has a pigment to binder volume ratio exceeding the critical pigment volume concentration to achieve at least one air void, wherein the at least one air void has a refractive index of about 1.

61. The method of claim 60, wherein the at least one air void has a diameter and the diameters have a distribution with a standard deviation of greater than 1 μm for broadband solar scattering.

62. The method of claim 41, wherein the binder material is water soluble, and comprises at least one of fluoropolymer, silicone, and fluoropolymer-acrylic latexes.

63. The method of claim 41, wherein the binder material is not water soluble, and comprises poly(vinylidene fluoride) or poly(vinylidene fluoride-co-hexafluoropropene).

64. The method of claim 41, further comprising at least one coalescing agent.

65. The method of claim 64, wherein the coalescing agent is triethyl phosphate, polyethylene glycol, or 2-Butoxyethanol.

66. The method of claim 41, further comprising at least one thickening agent.

67. The method of claim 66, wherein the thickening agent is methylcellulose.

68. The method of claim 41, wherein the coating is a paint or a spray.
